(19) United States
(12) Patent Application Publication
(10) Pub. No.: US 2009/0266991 A1
(43) Pub. Date: Oct. 29, 2009

(54) METHOD OF AUTHENTICATING TAGGED POLYMERS

(75) Inventors: Thomas L. Evans, Mount Vernon, IN (US); Sriramakrishna Maruvada, Evansville, IN (US); Vandita Pai-Paranjape, Evansville, IN (US); Philippe Schottland, West Chester, OH (US); David Lawrence Zoller, Evansville, IN (US)

Correspondence Address: CANTOR COLBURN LLP - SABIC (LEXAN/CYCOLOY), 20 Church Street, 22nd Floor, Hartford, CT, 06103, US

(73) Assignee: SABIC INNOVATIVE PLASTICS IP B.V., Bergen op Zoom (NL)

(21) Appl. No.: 12/258,176

(22) Filed: Oct. 24, 2008

Related U.S. Application Data
(63) Continuation-in-part of application No. 10/723,810, filed on Nov. 26, 2003, now abandoned.

(51) Int. Cl. G01N 31/00; G01T 1/20

(52) U.S. Cl. 250/362; 252/408.1

(57) ABSTRACT

In one embodiment, a tagged polymer composition, comprises: a base polymer composition comprising a forensic polymer composition and a dynamic response authentication marker. The forensic polymer composition comprises a marked polymer having a forensic authentication marker. The forensic authentication marker is present in an amount sufficient to be detected by a forensic analytical technique. The dynamic response authentication marker is present in an amount sufficient to be detected by a dynamic response analytical technique and wherein, when tested, the dynamic response authentication marker has a change in mode.

### CROSS-REFERENCE TO RELATED APPLICATIONS

This application is a continuation-in-part application of U.S. patent application Ser. No. 10/723,810, filed Nov. 26, 2003, which is incorporated by reference herein in its entirety.

### BACKGROUND

The present application relates to authentication technology for polymer based articles, particularly to methods of authenticating polymer based articles, methods of facilitating such authentication, and methods of making articles capable of authentication. The present application also relates to authentication technology for use in data storage media made of polycarbonate such as compact disks (CDs) and digital versatile disks (DVDs).

Data storage media or optical storage media such as CDs and DVDs traditionally contain information such as machine-readable code, audio, video, text, and/or graphics. Data storage media often include one or more substrates made of polymers such as polycarbonate.

A major problem confronting the various makers and users of data storage media is the unauthorized reproduction or copying of information by unauthorized manufactures, sellers and/or users. Such unauthorized reproduction or duplication of data storage media is often referred to as piracy and can occur in a variety of ways, including consumer level piracy at the point of end use as well as wholesale duplication of data, substrate and anti-piracy information at the commercial level. Regardless of the manner, piracy of data storage media deprives legitimate software and entertainment content providers and original electronic equipment manufacturers significant revenue and profit.

Attempts to stop piracy at the consumer level have included the placement of electronic anti-piracy signals on information carrying substrates along with the information sought to be protected. The machine readers and players of such data storage media are configured to require the identification of such anti-piracy signals prior to allowing access to the desired information. Theoretically, consumer level duplications are unable to reproduce these electronic anti-piracy signals on unauthorized copies and hence result in duplicates and copies that are unusable.

However, numerous technologies to thwart such consumer level anti-piracy technologies have been and continue to be developed. Moreover, commercial level duplications have evolved to the point that unauthorized duplicates now contain the original electronic anti-piracy circuit, code, etc. For example, commercial level duplication methods include pit copying, radio frequency (RF) copying, “bit to bit” copying and other mirror image copying techniques which result in the placement of the anti-piracy signal on the information carrying substrate of the duplicate along with the information sought to be protected. In other cases, the computer code is modified to remove all anti-piracy information to provide free access to the desired data.

One anti-piracy technology aimed at combating these more sophisticated consumer and commercial level reproduction and copying practices involves the placement of ‘tags’ or authentication markers in substrates used in the construction of data storage media. Such tags or authentication markers can be detected at one or more points along the data storage media manufacturing or distribution chain or by the end use reader or player used to access the data on a particular CD or DVD.

For example, in Cyr et al., U.S. Pat. No. 6,099,930, tagging materials are placed in materials such as digital compact disks. A near-infrared fluorophore is incorporated into the compact disk via coating, admixing, blending or copolymerization. Fluorescence is detectable when the fluorophore is exposed to electromagnetic radiation having a wavelength ranging from 670 to 1100 nanometers.

Hubbard et al., U.S. Pat. No. 6,514,617 discloses a polymer comprising a tagging material wherein the tagging material comprises an organic fluorophore dye, an inorganic fluorophore, an organometallic fluorophore, a semi-conducting luminescent nanoparticle, or combination thereof, wherein the tagging material has a temperature stability of at least about 350 degrees C. and is present in a sufficient quantity such that the tagging material is detectable via a spectrofluorometer at an excitation wavelength from about 100 nanometers to about 1100 nanometers.

WO 00/14736 relies on one or more intrinsic physical or chemical characteristics of the substrate materials to distinguish unauthorized duplications of information-carrying substrates. Such anti-piracy characteristics may be based on performance characteristics such as (for example in the case of an optical disk) the weight and/or density of the disk; the spin rate of the disk; the acceleration and deceleration of the disk; the inertia of the disk; the spectral characteristics such as reflectance of the disk; the optical characteristics such as light transmittance of the disk; the water absorption and dimensional stability of the disk; the data transfer rate of the disk; and the degree of wobble of the disk, or combinations of such characteristics.

However, the ability of unauthorized manufacturers, sellers, and/or users of data storage media to circumvent such practices continues to grow with increasingly sophisticated practices. For example, unauthorized manufacturers of data storage media are known to illegally obtain legitimately manufactured-tagged substrates for the purposes of making unauthorized reproductions. Moreover, the high profitability of piracy has enabled some unauthorized manufacturers and their suppliers to reverse engineer tagged substrate materials for the purpose of identifying previously unknown tags and producing similarly tagged data media storage substrate.

There is therefore a need to find methods of tagging and authenticating data storage media substrates that are currently unknown and/or unavailable to unauthorized manufacturers, sellers, and/or users of data storage media. In particular, it would be desirable to find authentication markers or combinations of authentication markers for use in data storage media substrates for the purposes of authenticating data storage media substrates and data storage media. Such markers would be desirably difficult to obtain, reproduce, use, and/or identify.

### BRIEF DESCRIPTION

Disclosed herein are embodiments for methods of authenticating an article or tagged polymer.

In one embodiment, a tagged polymer composition, comprises: a base polymer composition comprising a forensic polymer composition and a dynamic response authentication marker. The forensic polymer composition comprises a marked polymer having a forensic authentication marker. The forensic authentication marker is present in an amount sufficient to be detected by a forensic analytical technique. The dynamic response authentication marker is present in an amount sufficient to be detected by a dynamic response analytical technique and wherein, when tested, the dynamic response authentication marker has a change in mode.

In one embodiment, the method of authenticating that a test polymer is a tagged polymer composition can comprise: testing the test polymer for the forensic authentication marker using a forensic analytical technique; testing the test polymer for the dynamic response authentication marker using a dynamic response analytical technique; and authenticating that a test polymer is a tagged polymer composition if the forensic authentication marker and dynamic authentication marker are detected.

### BRIEF DESCRIPTION OF THE DRAWINGS

Referring now to the figures, which are exemplary embodiments, and wherein the like elements are numbered alike:

FIG. 1 represents a graphical representation of shear viscosity expressed in Pa-s versus shear rate expressed in s⁻¹ (or Hz) for Formulations A and B of Example 1 as measured at 300° C. on a capillary rheometer.

FIG. 2 is a spectrum of an approximately 2.5% solution of dimethyl bisphenol cyclohexane (DMBPC) copolymer in deuterated chloroform (99% purity) as analyzed by a Varian Mercury-400 proton nuclear magnetic resonance (NMR) spectrometer.

FIG. 3 is a graphical representation of a comparison of the fluorescence emission of Formulations A and B when excited at 355 nm showing unique spectral signature of a dynamic response authentication marker that is a long stokes shift green emitting UV fluorophore dye in Formulation B.

FIG. 4 is a graphical comparison of the absorption spectra of Formulations A and B.

FIG. 5 is a graphical comparison of the transmission spectra of Formulations A and B.

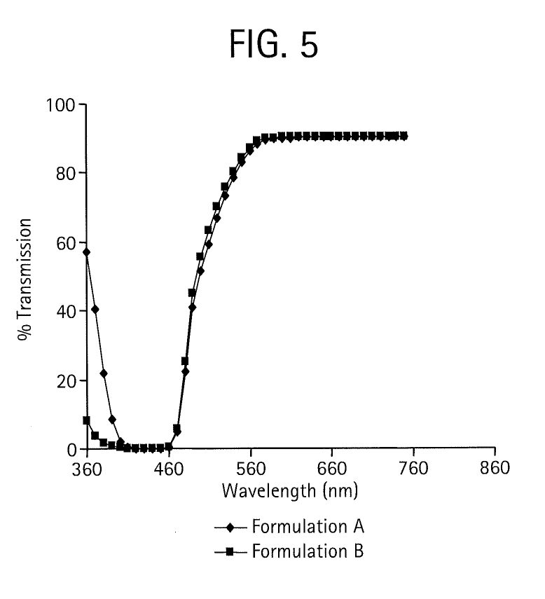

### DETAILED DESCRIPTION

Multi-level tagging methods of facilitating the authentication of polymer-based or polymer-containing articles are provided. Such methods result in the production of tagged polymers that can be used to make tagged articles. The presence of the particularly disclosed authentication markers (i.e., forensic authentication markers and dynamic response authentication markers) in the tagged polymers or articles made therefrom allows for one or more parties at any point along the manufacturing chain, distribution chain, point of sale or point of use of the tagged polymer or article to confirm or identify one or more pieces of information. Illustrative examples of the type of information which might be identified or confirmed include the source of the tagged polymer, the source of the tagged article, the composition of the tagged polymer, whether the tagged article is an unauthorized reproduction or duplication, the lot number of the tagged polymer, the serial number of the tagged article, and the like.

The tagged polymer composition or article comprises a base polymer composition, a forensic authentication marker, and a dynamic response authentication marker. For example, the tagged polymer composition or article comprises a base polymer composition, a forensic polymer composition comprising a marked polymer having a forensic authentication marker, and a dynamic response authentication marker).

Methods for authenticating a tagged polymer composition and a tagged article as disclosed herein include the use of forensic analytical technique(s) and dynamic response analytical technique(s) which are used to determine if the forensic authentication marker and dynamic response authentication marker, respectively, are present.

In an embodiment, a tagged polymer composition comprises a base polymer composition comprising a forensic polymer composition and a dynamic response authentication marker, where the forensic polymer composition comprises a marked polymer having a forensic authentication marker. The forensic authentication marker is present in an amount sufficient to be detected by a forensic analytical technique. The dynamic response authentication marker is present in an amount sufficient to be detected by a dynamic response analytical technique and where when tested, the dynamic response authentication marker has a change in mode.

The tagged polymer composition can further comprise the forensic authentication marker and the dynamic response authentication marker being present in an amount such that properties of the tagged polymer composition including optical, physical, Theological, thermal, and processing properties vary from the base polymer composition less than or equal to 20%. The tagged polymer composition can also comprise the forensic authentication marker being present in the tagged polymer in an amount of less than or equal to about 10 wt %, based on the total weight of the tagged polymer composition, specifically less than or equal to about 0.5 wt %.

The tagged polymer composition can further comprise the forensic authentication marker being a member selected from the group consisting of alkyl groups of 2 or more carbon atoms, cycloaliphatic groups of 3 or more carbon atoms, —OCH₃ groups, —CH₃Si groups, methyl groups attached to an aryl moiety, divalent substituted phenol groups, terminal substituted phenol groups, and (—CH₂—)ₙ, groups where n is a number of from 4 to 14. The forensic authentication marker can be alkyl groups of 2 or more carbon atoms, cycloaliphatic groups of 3 or more carbon atoms, —OCH₃ groups, —CH₃Si groups, methyl group(s) attached to an aryl moiety, divalent substituted phenol group(s), and terminal substituted phenol group(s), DMBPC structural unit(s), and combinations comprising at least one of the foregoing; and the dynamic response authentication marker can be fluorophore(s), a semi-conducting luminescent nanoparticle(s), and combinations comprising at least one of the foregoing. The tagged polymer composition can further comprise the base polymer composition comprising polycarbonate, the forensic authentication marker can be a monomer of a copolymer miscible with the base polymer composition, specifically DMBPC structural unit(s). For example, the forensic analytical marker can be DMBPC structural unit(s) and the dynamic response analytical marker can be fluorophore(s).

The tagged polymer composition can further comprise the dynamic response authentication marker comprising a fluorophore, a semi-conducting luminescent nanoparticle, and mixtures comprising at least one of the foregoing and being present in the tagged polymer in an amount of about 10⁻⁵ wt % to about 0.1 wt %, based on the total weight of the tagged polymer composition.

In an embodiment, a molded article comprises the tagged polymer. The molded article can be a data storage media.

In an embodiment, a method of authenticating that a test polymer is a tagged polymer comprises testing the test polymer for the forensic authentication marker using a forensic analytical technique, testing the test polymer for the dynamic response authentication marker using a dynamic response analytical technique, and authenticating that a test polymer is a tagged polymer composition if the forensic authentication marker and dynamic authentication marker are detected.

The forensic analytical technique can be a resonance spectroscopy method, SEM-EDX, XPS-ESCA, gas or liquid chromatography, and combinations comprising at least one of the foregoing forensic analytical techniques. The dynamic response analytical technique can be luminescence spectroscopy, fluorescence spectroscopy, vibrational spectroscopy, electronic spectroscopy, visual observation under specific lighting conditions, color spectrophotometry, and combinations comprising at least one of the foregoing dynamic response analytical techniques. Optionally, the forensic analytical technique can be NMR and/or HPLC, and the dynamic response analytical technique can be visual observation, luminescence spectroscopy, and/or fluorescence spectroscopy. In some embodiments, the forensic analytical technique can be NMR and the dynamic response analytical technique being fluorescence spectroscopy, or the forensic analytical technique can be HPLC and the dynamic response analytical technique can be fluorescence spectroscopy.

In an embodiment, the tagged polymer composition comprises a forensic polymer composition (comprising a marked polymer having a forensic authentication marker) and a dynamic response authentication marker where the forensic authentication marker and the dynamic response authentication marker are both subject to proprietary controls such as technology agreements, patents, license agreements and the like (e.g., SABIC Innovative Plastics can be the only supplier of the forensic authentication marker; SABIC Innovative Plastics can have an exclusive license agreement for the dynamic response authentication marker). In another embodiment, the forensic authentication marker and dynamic response authentication marker are materials that are difficult to manufacture without significant capital investment in equipment and/or processes (i.e., difficult for a third party to duplicate in an attempt to manufacture an unauthorized version of the tagged polymer composition or articles made from such materials because of the material and equipment and/or processes used). In an exemplary embodiment, the forensic authentication marker and dynamic response authentication marker are subject to proprietary controls and require extensive manufacturing investment for their production. In this way, the forensic authentication marker and dynamic response authentication marker are less likely to be obtained by third parties attempting to manufacture unauthorized versions of the tagged polymer composition or articles made from such materials. Limits on the commercial availability of certain forensic authentication markers and dynamic response authentication markers increase the likelihood that certain forensic authentication markers and dynamic response authentication markers can maintain their value as ‘tagging’ tools in the authentication of base polymer compositions used in the manufacture of articles such as data storage media due to their unavailability to illegitimate users and makers of these articles.

In an embodiment, the forensic authentication marker and dynamic response authentication marker are present in the tagged polymer composition in an amount sufficient to be detectable by a forensic analytical technique and a dynamic response analytical technique, respectively, wherein, desirably the forensic authentication marker and dynamic response authentication marker are present in a low enough concentration that they do not affect one or more physical or performance properties of the base polymer composition.

Illustrative examples of physical properties and performance properties of the base polymer not affected by the addition of the forensic authentication marker in an amount sufficient to be detected by a forensic analytical technique and the dynamic response authentication marker in an amount sufficient to be detected by a dynamic response analytical technique include optical, physical, rheological, thermal, and processing properties. Illustrative optical properties include light transmission, birefringence, and color. Examples of physical properties include moisture absorption, coefficients of thermal expansion, and the like, while examples of mechanical properties include flexural modulus, tensile modulus, impact resistance, and the like. Illustrative rheological properties include the viscosity of the substrate polymer, especially melt viscosity and melt viscosity rate as measured per ISO 1133 method. Thermal properties include glass transition temperature of the substrate and heat deflection temperature. Illustrative processing properties include the required molding temperature(s), including nozzle and barrel temperatures, injection rates and the like.

In an embodiment, the optical and rheological properties of the base polymer composition will be unaffected by the addition of the forensic authentication marker and the dynamic response authentication marker. In another exemplary embodiment, the rheological properties of the base polymer composition will be unaffected by the addition of the forensic authentication marker and the dynamic response authentication marker. In another exemplary embodiment, the optical properties of the base polymer composition will be unaffected by the addition of the forensic authentication marker and the dynamic response authentication marker.

In a specific embodiment, one or more of the physical and/or performance properties of the resultant tagged polymer composition will vary from those of the base polymer composition in an amount less than or equal to about 20%, specifically, less than or equal to about 15%, more specifically, less than or equal to about 10%, and even more specifically, less than or equal to about 5% (e.g., 0% to about 5%) of the value of the particular performance and/or physical property of the base polymer composition.

Some possible examples of polymers which can be utilized in the base polymer composition include, but are not limited to, amorphous, crystalline and semi-crystalline thermoplastic materials: polyvinyl chloride, polyolefins (including, but not limited to, linear and cyclic polyolefins and including polyethylene, chlorinated polyethylene, polypropylene, and the like), polyesters (including, but not limited to, polyethylene terephthalate, polybutylene terephthalate, polycyclohexylmethylene terephthalate, and the like), polyamides, polysulfones (including, but not limited to, hydrogenated polysulfones, and the like), polyimides, polyether imides, polyether sulfones, polyphenylene sulfides, polyether ketones, polyether ether ketones, ABS resins, polystyrenes (including, but not limited to, hydrogenated polystyrenes, syndiotactic and atactic polystyrenes, polycyclohexyl ethylene, styrene-co-acrylonitrile, styrene-co-maleic anhydride, and the like), polybutadiene, polyacrylates (including, but not limited to, polymethylmethacrylate, methyl methacrylate-polyimide copolymers, and the like), polyacrylonitrile, polyacetals, polycarbonates, polyphenylene ethers (including, but not limited to, those derived from 2,6-dimethylphenol and copolymers with 2,3,6-trimethylphenol, and the like), ethylene-vinyl acetate copolymers, polyvinyl acetate, liquid crystal polymers, ethylene-tetrafluoroethylene copolymer, aromatic polyesters, polyvinyl fluoride, polyvinylidene fluoride, polyvinylidene chloride, fluoropolymers such as Teflon™, as well as thermosetting resins such as epoxy, phenolic, alkyds, polyester, polyimide, polyurethane, mineral filled silicone, bis-maleimides, cyanate esters, vinyl, and benzocyclobutene resins, in addition to blends, copolymers, mixtures, reaction products and composites comprising at least one of the foregoing plastics. In an exemplary embodiment, polycarbonate is used as the base polymer composition.

As used herein, the term “polycarbonate” means compositions having repeating structural carbonate units of formula (1)

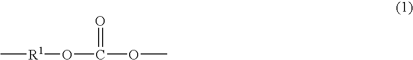

in which at least 60 percent of the total number of R¹ groups contain aromatic moieties and the balance thereof are aliphatic, alicyclic, or aromatic. In an embodiment, each R¹ is a C₆₋₃₀ aromatic group, that is, contains at least one aromatic moiety. R¹ can be derived from a dihydroxy compound of the formula HO—R¹—OH, in particular of formula (2)

HO-A¹-Y¹-A²-OH (2)

wherein each of A¹ and A² is a monocyclic divalent aromatic group and Y¹ is a single bond or a bridging group having one or more atoms that separate A¹ from A². In an exemplary embodiment, one atom separates A¹ from A². Specifically, each R¹ can be derived from a dihydroxy aromatic compound of formula (3)

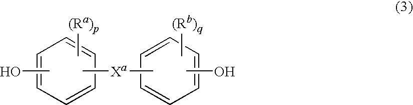

wherein R^{a} and R^{b} each represent a halogen or C₁₋₁₂ alkyl group and can be the same or different; and p and q are each independently integers of 0 to 4. X^{a} represents a single bond or a bridging group connecting the two hydroxy-substituted aromatic groups, where the single bond or the bridging group and the hydroxy substituent of each C₆ arylene group are disposed ortho, meta, or para (specifically para) to each other on the C₆ arylene group. In an embodiment, the bridging group X^{a} is —O—, —S—, —S(O)—, —S(O)₂—, —C(O)—, or a C₁₋₁₈ organic group. The C₁₋₁₈ organic group can be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic group. In one embodiment, p and q is each 1, and R^{a} and R^{b} are each a C₁₋₃ alkyl group, specifically methyl, disposed meta to the hydroxy group on each arylene group.

In an embodiment, X^{a} is a substituted or unsubstituted C₃₋₁₈ cycloalkylidene, a C₁₋₂₅ alkylidene of formula —C(R^{c})(R^{d})— wherein R^{c} and R^{d} are each independently hydrogen, C₁₋₁₂ alkyl, C₁₋₁₂ cycloalkyl, C₇₋₁₂ arylalkyl, C₁₋₁₂ heteroalkyl, or cyclic C₇₋₁₂ heteroarylalkyl, or a group of the formula —C(═R^{e})— wherein R^{e} is a divalent C₁₋₁₂ hydrocarbon group. Exemplary groups of this type include methylene, cyclohexylmethylene, ethylidene, neopentylidene, and isopropylidene, as well as 2-[2.2.1]-bicycloheptylidene, cyclohexylidene, cyclopentylidene, cyclododecylidene, and adamantylidene. A specific example wherein X^{a} is a substituted cycloalkylidene is the cyclohexylidene-bridged, alkyl-substituted bisphenol of formula (4)

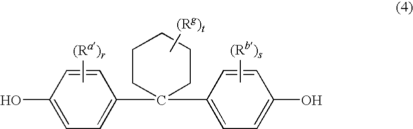

wherein R^{a′} and R^{b′} are each independently C₁₋₁₂ alkyl, R^{g} is C₁₋₁₂ alkyl or halogen, r and s are each independently 1 to 4, and t is 0 to 10. In a specific embodiment, at least one of each of R^{a′} and R^{b′} are disposed meta to the cyclohexylidene bridging group. The substituents R^{a′}, R^{b′}, and R^{g} can, when comprising an appropriate number of carbon atoms, be straight chain, cyclic, bicyclic, branched, saturated, or unsaturated. In an embodiment, R^{a′} and R^{b′} are each independently C₁₋₄ alkyl, R^{g} is C₁₋₄ alkyl, r and s are each 1, and t is 0 to 5. In another specific embodiment, R^{a′}, R^{b′} and R^{g} are each methyl, r and s are each 1, and t is 0 or 3. The cyclohexylidene-bridged bisphenol can be the reaction product of two moles of o-cresol with one mole of cyclohexanone. In another exemplary embodiment, the cyclohexylidene-bridged bisphenol is the reaction product of two moles of a cresol with one mole of a hydrogenated isophorone (e.g., 1,1,3-trimethyl-3-cyclohexane-5-one). Such cyclohexane-containing bisphenols, for example the reaction product of two moles of a phenol with one mole of a hydrogenated isophorone, are useful for making polycarbonate polymers with high glass transition temperatures and high heat distortion temperatures.

X^{a} can also be a substituted C₃₋₁₈ cycloalkylidene of formula (5)

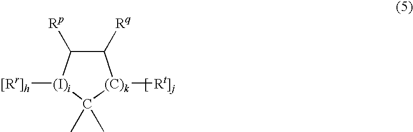

wherein R^{r}, R^{p}, R^{q}, and R^{t} are independently hydrogen, halogen, oxygen, or C₁₋₁₂ organic groups; I is a direct bond, a carbon, or a divalent oxygen, sulfur, or —N(Z)- where Z is hydrogen, halogen, hydroxy, C₁₋₁₂ alkyl, C₁₋₁₂ alkoxy, or C₁₋₁₂ acyl; h is 0 to 2, j is 1 or 2, i is an integer of 0 or 1, and k is an integer of 0 to 3, with the proviso that at least two of R^{r}, R^{P}, R^{q}, and R^{t} taken together are a fused cycloaliphatic, aromatic, or heteroaromatic ring. It will be understood that where the fused ring is aromatic, the ring as shown in formula (5) will have an unsaturated carbon-carbon linkage where the ring is fused. When k is one and i is 0, the ring as shown in formula (5) contains 4 carbon atoms, when k is 2, the ring as shown in formula (5) contains 5 carbon atoms, and when k is 3, the ring contains 6 carbon atoms. In one embodiment, two adjacent groups (e.g., R^{q} and R^{t} taken together) form an aromatic group, and in another embodiment, R^{q} and R^{t} taken together form one aromatic group and R^{r} and R^{P} taken together form a second aromatic group. When R^{q} and R^{t} taken together form an aromatic group, R^{P} can be a double-bonded oxygen atom, i.e., a ketone.

Other useful aromatic dihydroxy compounds of the formula HO—R¹—OH include compounds of formula (6)

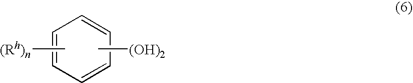

wherein each R^{h} is independently a halogen atom, a C₁₋₁₀ hydrocarbyl such as a C₁₋₁₀ alkyl group, a halogen-substituted C₁₋₁₀ alkyl group, a C₆₋₁₀ aryl group, or a halogen-substituted C₆₋₁₀ aryl group, and n is 0 to 4. The halogen is usually bromine.

Some illustrative examples of specific aromatic dihydroxy compounds include the following: 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis(hydroxyphenyl)cyclopentane, 1,1-bis(4-hydroxyphenyl)cyclohexane, 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantane, alpha,alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorine, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalimide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole, resorcinol, substituted resorcinol compounds such as 5-methyl resorcinol, 5-ethyl resorcinol, 5-propyl resorcinol, 5-butyl resorcinol, 5-t-butyl resorcinol, 5-phenyl resorcinol, 5-cumyl resorcinol, 2,4,5,6-tetrafluoro resorcinol, 2,4,5,6-tetrabromo resorcinol, or the like; catechol; hydroquinone; substituted hydroquinones such as 2-methyl hydroquinone, 2-ethyl hydroquinone, 2-propyl hydroquinone, 2-butyl hydroquinone, 2-t-butyl hydroquinone, 2-phenyl hydroquinone, 2-cumyl hydroquinone, 2,3,5,6-tetramethyl hydroquinone, 2,3,5,6-tetra-t-butyl hydroquinone, 2,3,5,6-tetrafluoro hydroquinone, 2,3,5,6-tetrabromo hydroquinone, or the like, or combinations comprising at least one of the foregoing dihydroxy compounds.

Specific examples of bisphenol compounds of formula (3) include 1,1-bis(4-hydroxyphenyl)methane, 1,1-bis(4-hydroxyphenyl)ethane, 2,2-bis(4-hydroxyphenyl)propane (hereinafter “bisphenol A” or “BPA”), 2,2-bis(4-hydroxyphenyl)butane, 2,2-bis(4-hydroxyphenyl)octane, 1,1-bis(4-hydroxyphenyl)propane, 1,1-bis(4-hydroxyphenyl)n-butane, 2,2-bis(4-hydroxy-2-methylphenyl)propane, 1,1-bis(4-hydroxy-t-butylphenyl)propane, 3,3-bis(4-hydroxyphenyl)phthalimidine, 2-phenyl-3,3-bis(4-hydroxyphenyl)phthalimidine (PPPBP), and 1,1-bis(4-hydroxy-3-methylphenyl)cyclohexane (DMBPC). Combinations comprising at least one of the foregoing dihydroxy compounds can also be used. In one specific embodiment, the polycarbonate is a linear homopolymer derived from bisphenol A, in which each of A¹ and A² is p-phenylene and Y¹ is isopropylidene in formula (3).

“Polycarbonates” as used herein further include homopolycarbonates, (wherein each R¹ in the polymer is the same), copolymers comprising different R¹ moieties in the carbonate (referred to herein as “copolycarbonates”), copolymers comprising carbonate units and other types of polymer units, such as ester units, and combinations comprising at least one of homopolycarbonates and/or copolycarbonates. As used herein, a “combination” is inclusive of blends, mixtures, alloys, reaction products, and the like.

A specific type of copolymer is a polyester carbonate, also known as a polyester-polycarbonate. Such copolymers further contain, in addition to recurring carbonate chain units of formula (1), repeating units of formula (7)

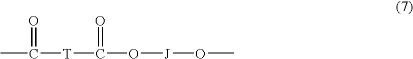

wherein J is a divalent group derived from a dihydroxy compound, and can be, for example, a C₂₋₁₀ alkylene group, a C₆₋₂₀ alicyclic group, a C₆₋₂₀ aromatic group or a polyoxyalkylene group in which the alkylene groups contain 2 to about 6 carbon atoms, specifically 2, 3, or 4 carbon atoms; and T divalent group derived from a dicarboxylic acid, and can be, for example, a C₂₋₁₀ alkylene group, a C₆₋₂₀ alicyclic group, a C₆₋₂₀ alkyl aromatic group, or a C₆₋₂₀ aromatic group. Copolyesters containing a combination of different T and/or J groups can be used. The polyesters can be branched or linear.

In one embodiment, J is a C₂₋₃₀ alkylene group having a straight chain, branched chain, or cyclic (including polycyclic) structure. In another embodiment, J is derived from an aromatic dihydroxy compound of formula (3) above. In another embodiment, J is derived from an aromatic dihydroxy compound of formula (4) above. In another embodiment, J is derived from an aromatic dihydroxy compound of formula (6) above.

Exemplary aromatic dicarboxylic acids that can be used to prepare the polyester units include isophthalic or terephthalic acid, 1,2-di(p-carboxyphenyl)ethane, 4,4′-dicarboxydiphenyl ether, 4,4′-bisbenzoic acid, or a combination comprising at least one of the foregoing acids. Acids containing fused rings can also be present, such as in 1,4-, 1,5-, or 2,6-naphthalenedicarboxylic acids. Specific dicarboxylic acids include terephthalic acid, isophthalic acid, naphthalene dicarboxylic acid, cyclohexane dicarboxylic acid, or a combination comprising at least one of the foregoing acids. A specific dicarboxylic acid comprises a combination of isophthalic acid and terephthalic acid wherein the weight ratio of isophthalic acid to terephthalic acid is about 91:9 to about 2:98. In another specific embodiment, J is a C₂₋₆ alkylene group and T is p-phenylene, m-phenylene, naphthalene, a divalent cycloaliphatic group, or a combination thereof. This class of polyester includes the poly(alkylene terephthalates).

The molar ratio of ester units to carbonate units in the copolymers can vary broadly, for example 1:99 to 99:1, specifically 10:90 to 90:10, more specifically 25:75 to 75:25, depending on the desired properties of the final composition.

In a specific embodiment, the polyester unit of a polyester-polycarbonate is derived from the reaction of a combination of isophthalic and terephthalic diacids (or derivatives thereof) with resorcinol. In another specific embodiment, the polyester unit of a polyester-polycarbonate is derived from the reaction of a combination of isophthalic acid and terephthalic acid with bisphenol A. In a specific embodiment, the polycarbonate units are derived from bisphenol A. In another specific embodiment, the polycarbonate units are derived from resorcinol and bisphenol A in a molar ratio of resorcinol carbonate units to bisphenol A carbonate units of 1:99 to 99:1.

Polycarbonates can be manufactured by processes such as interfacial polymerization and melt polymerization. Although the reaction conditions for interfacial polymerization can vary, an exemplary process generally involves dissolving or dispersing a dihydric phenol reactant in aqueous caustic soda or potash, adding the resulting mixture to a water-immiscible solvent medium, and contacting the reactants with a carbonate precursor in the presence of a catalyst such as triethylamine and/or a phase transfer catalyst, under controlled pH conditions, e.g., about 8 to about 12. The most commonly used water immiscible solvents include methylene chloride, 1,2-dichloroethane, chlorobenzene, toluene, and the like.

Exemplary carbonate precursors include a carbonyl halide such as carbonyl bromide or carbonyl chloride, or a haloformate such as a bishaloformates of a dihydric phenol (e.g., the bischloroformates of bisphenol A, hydroquinone, or the like) or a glycol (e.g., the bishaloformate of ethylene glycol, neopentyl glycol, polyethylene glycol, or the like). Combinations comprising at least one of the foregoing types of carbonate precursors can also be used. In an exemplary embodiment, an interfacial polymerization reaction to form carbonate linkages uses phosgene as a carbonate precursor, and is referred to as a phosgenation reaction.

Among the phase transfer catalysts that can be used are catalysts of the formula (R³)₄Q⁺X, wherein each R³ is the same or different, and is a C₁₋₁₀ alkyl group; Q is a nitrogen or phosphorus atom; and X is a halogen atom or a C₁₋₈ alkoxy group or C₆₋₁₈ aryloxy group. Exemplary phase transfer catalysts include, for example, [CH₃(CH₂)₃]₄NX, [CH₃(CH₂)₃]₄PX, [CH₃(CH₂)₅]₄NX, [CH₃(CH₂)₆]₄NX, [CH₃(CH₂)₄]₄NX, CH₃[CH₃(CH₂)₃]₃NX, and CH₃[CH₃(CH₂)₂]₃NX, wherein X is Cl⁻, Br⁻, a C₁₋₈ alkoxy group or a C₆₋₁₈ aryloxy group. An effective amount of a phase transfer catalyst can be about 0.1 to about 10 wt % based on the weight of bisphenol in the phosgenation mixture. In another embodiment an effective amount of phase transfer catalyst can be about 0.5 to about 2 wt % based on the weight of bisphenol in the phosgenation mixture.

All types of polycarbonate end groups are contemplated as being useful in the polycarbonate composition, provided that such end groups do not significantly adversely affect desired properties of the compositions.

Branched polycarbonate blocks can be prepared by adding a branching agent during polymerization. These branching agents include polyfunctional organic compounds containing at least three functional groups selected from hydroxyl, carboxyl, carboxylic anhydride, haloformyl, and mixtures of the foregoing functional groups. Specific examples include trimellitic acid, trimellitic anhydride, trimellitic trichloride, tris-p-hydroxy phenyl ethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl)alpha,alpha-dimethyl benzyl)phenol), 4-chloroformyl phthalic anhydride, trimesic acid, and benzophenone tetracarboxylic acid. The branching agents can be added at a level of about 0.05 to about 2.0 wt %. Mixtures comprising linear polycarbonates and branched polycarbonates can be used.

Alternatively, melt processes can be used to make the polycarbonates. Generally, in the melt polymerization process, polycarbonates can be prepared by co-reacting, in a molten state, the dihydroxy reactant(s) and a diaryl carbonate ester, such as diphenyl carbonate, in the presence of a transesterification catalyst in a Banbury mixer, twin screw extruder, or the like to form a uniform dispersion. Volatile monohydric phenol is removed from the molten reactants by distillation and the polymer is isolated as a molten residue. A specifically useful melt process for making polycarbonates uses a diaryl carbonate ester having electron-withdrawing substituents on the aryls. Examples of specifically useful diaryl carbonate esters with electron withdrawing substituents include bis(4-nitrophenyl)carbonate, bis(2-chlorophenyl)carbonate, bis(4-chlorophenyl)carbonate, bis(methyl salicyl)carbonate, bis(4-methylcarboxylphenyl)carbonate, bis(2-acetylphenyl)carboxylate, bis(4-acetylphenyl)carboxylate, or a combination comprising at least one of the foregoing esters. In addition, useful transesterification catalysts can include phase transfer catalysts of formula (R³)₄Q⁺X, wherein each R³, Q, and X are as defined above. Exemplary transesterification catalysts include tetrabutylammonium hydroxide, methyltributylammonium hydroxide, tetrabutylammonium acetate, tetrabutylphosphonium hydroxide, tetrabutylphosphonium acetate, tetrabutylphosphonium phenolate, or a combination comprising at least one of the foregoing.

In an embodiment the tagged polymer composition or tagged article can also include various additives ordinarily incorporated in resin compositions of this type. Such additives are, for example, fillers or reinforcing agents; heat stabilizers; antioxidants; light stabilizers; plasticizers; antistatic agents; mold releasing agents; additional resins; blowing agents; and the like, as well as combinations of the foregoing additives. Examples of fillers or reinforcing agents include glass fibers, asbestos, carbon fibers, silica, talc, and calcium carbonate. Examples of heat stabilizers include triphenyl phosphite, tris-(2,6-dimethylphenyl)phosphite, tris-(mixed mono- and di-nonylphenyl)phosphite, dimethylbenzene phosphonate, and trimethyl phosphate. Examples of antioxidants include octadecyl-3-(3,5-di-tert-butyl-4-hydroxyphenyl)propionate, and pentaerythrityl-tetrakis[3-(3,5-di-tert-butyl-4-hydroxyphenyl)propionate]. Examples of light stabilizers include 2-(2-hydroxy-5-methylphenyl)benzotriazole, 2-(2-hydroxy-5-tert-octylphenyl)-benzotriazole and 2-hydroxy-4-n-octoxy benzophenone. Examples of plasticizers include dioctyl-4,5-epoxy-hexahydrophthalate, tris-(octoxycarbonylethyl)isocyanurate, tristearin, and epoxidized soybean oil. Examples of the antistatic agent include glycerol monostearate, sodium stearyl sulfonate, and sodium dodecylbenzenesulfonate. Examples of mold releasing agents include stearyl stearate, beeswax, montan wax, and paraffin wax. Examples of other resins include but are not limited to polypropylene, polystyrene, polymethyl methacrylate, and polyphenylene oxide. Combinations of any of the foregoing additives may be used. Such additives may be mixed at a suitable time during the mixing of the components for forming the composition.

In an embodiment the tagged polymer composition or tagged article can also contain colorants that impart a specific appearance to the tagged polymer composition or tagged article under normal lighting conditions (e.g., daylight). In another embodiment, the colorants used exhibit no or only very weak fluorescence under UV excitation compared to the dynamic response marker discussed below. Suitable colorants include but are not limited to non-fluorescent derivatives of the following dye families: anthraquinones, methine, perinones, azo, anthrapyridones, and quinophtalones.

Forensic polymer composition as used herein refers to a composition comprising a marked polymer having a forensic authentication marker. Forensic authentication markers as described herein are structural units (e.g., end groups or copolymer units) that are part of the marked polymer. A forensic authentication marker is part of a marked polymer that forms a forensic polymer composition and it is a structural unit that is not present in the base polymer composition. The combination of the base polymer composition and the forensic polymer composition in combination with a dynamic response authentication marker results in a tagged polymer composition. The presences of the forensic authentication marker in the tagged polymer composition provides a unique signal detectable by a forensic analytical technique.

Illustrative examples of forensic authentication markers include alkyl groups of 2 or more carbons, cycloaliphatic groups of 3 or more carbons, —OCH₃ and CH₃Si groups, divalent substituted phenol groups such as eugenol, terminal substituted phenol groups such as p-cumylphenol (PCP), isophthalate and/or terephthalate groups, methyl groups attached to an aryl moiety (such as a phenol derivative), and the like. In one exemplary embodiment, the forensic authentication markers alkyl group(s) of from 2 to 40 carbon atoms and/or cycloaliphatic group(s) of from 3 to 40 carbon atoms.

In one exemplary embodiment, a suitable alkyl group is the methylene group. For example, the forensic authentication marker can be methylene groups of the structure —(CH₂)ₙ— wherein n is a number of greater than or equal to 2. In another embodiment, n can be a number of less than or equal to 30. In yet another exemplary embodiment, n can be a number of 4 to 14.

Forensic polymer compositions comprise the marked polymer, which can be in the form of oligomers, polymers, or copolymers (generally referred to herein as “polymer”. Oligomer as used herein refers to materials having from two to ten repeating units. Polymer as used herein refers to materials having more than ten repeating units. Copolymer as used herein refers to a material having more than ten total repeating units wherein at least two of the repeating units are different. Copolymer and polymer are used interchangeably herein. In one embodiment, forensic polymer composition do not include light changeable materials that absorb, reflect, emit or otherwise alter electromagnetic radiation directed thereto. In yet another embodiment, forensic polymer composition will not scatter, absorb or reflect light in such a way as to affect the playability of optical data storage media when the tagged polymer composition is used to make such articles.

The forensic polymer composition can have a number average molecular weight (Mn) of greater than or equal to about 2,000 Daltons, and generally about 5,000 to about 200,000 Daltons, specifically about 10,000 to about 100,000 Daltons, and more specifically about 15,000 to about 45,000 Daltons.

In an embodiment, the forensic polymer composition is a polymer miscible with the base polymer composition, e.g., wherein the base polymer composition is polycarbonate or a polycarbonate blend. Miscible as used herein refers to a polymer (e.g., a forensic authentication composition) that upon incorporation with the base polymer composition shows little or no phase separation at the concentration levels for the forensic authentication marker disclosed herein. Phase separation may be detected in the form of optical properties such as a haze. In general a miscible transparent copolymer can have less than 1% haze per ASTM D1003 when measured in a sample having a thickness of 3.2 mm.

In an embodiment, the forensic polymer composition is a polycarbonate copolymer comprising at least 5 mole % of structural units having the formula (8), wherein the structural units are the forensic authentication marker,

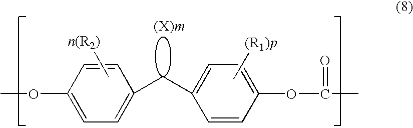

where R₁ and R₂ are independently selected from the group consisting of C₁-C₆ alkyl; X represents CH₂; m is an integer from 4 to 7; n is an integer from 1 to 4; and p is an integer from 1 to 4; with the proviso that one of R₁ or R₂ is in the 3 or 3′ position. In an embodiment, the forensic authentication marker is DMBPC, e.g., the forensic polymer composition is a copolymer having 25 mol % DMBPC structural units.

Unless otherwise stated, “mole %” in reference to the composition of a polycarbonate in this specification is based upon 100 mole % of the repeating units of the polycarbonate. For instance, “a polycarbonate comprising 90 mole % of BPA” refers to a polycarbonate in which 90 mol % of the repeating units are residues derived from BPA or its corresponding derivative(s). Corresponding derivatives include but are not limited to, corresponding oligomers of the diphenols; corresponding esters of the diphenols and their oligomers; and the corresponding chloroformates of the diphenols and their oligomers. The terms “residues” and “structural units”, used in reference to the constituents of the polycarbonate, are synonymous throughout the specification.

For example, the forensic polymer composition can be a polycarbonate copolymer (different from the base polymer composition) comprising about 1 to 100 mole % of structural units of formula (8), specifically about 10 to about 75 mole % of structural units of formula (8), where the forensic authentication marker is the structural unit of formula (8). In one particularly exemplary embodiment, the forensic polymer composition is a copolymer comprising greater than or equal to about 15 mole % of the structural units of formula (8) wherein m is 6, R₁ and R₂ are methyl groups in the 3 and 3′ positions, and both n and p are 1, where the forensic authentication marker is the structural unit of formula (8). The remaining structural residues may be obtained from other components of polycarbonate as described above with regard to the base polymer composition.

In another embodiment, the forensic polymer composition is a polyestercarbonate copolymer comprising greater than or equal to about 0.5 mole % of structural units having the formula (9):

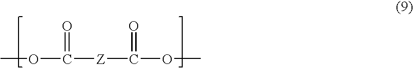

where Z is a C₁-C₄₀ branched or unbranched alkyl or branched or unbranched cycloalkyl, where the forensic authentication marker comprises the structural units of formula (9). In one exemplary embodiment, Z can have from 6 to 18 carbon atoms and in another embodiment from 10 to 14 carbon atoms. Representative units of structure (9) include, but are not limited to, residues of dodecanedioic acid, sebacic acid, adipic acid, octadecanedioic acid, octadec-9-enedioic acid, 9-carboxyoctadecanoic acid and 10-carboxyoctadecanoic acid, and combinations comprising at least one of the foregoing. In one exemplary embodiment, the copolymer will comprise residues of dodecanedioic acid (DDDA).

The copolymer can be a polyestercarbonate copolymer comprising about 0.5 to about 20 mole % of structural units of formula (9), specifically, about 1 to about 10 mole % of structural units of formula (9).

The tagged polymer composition can contain a forensic polymer composition having more than one forensic authentication marker. An example of a forensic polymer composition containing more than one forensic authentication marker is a BPA polycarbonate copolymer comprising the structural units of DMBPC and DDDA. If two forensic authentication markers are used, both should be present at a level detectable by the selected forensic analytical technique, and at a level that does not affect one or more optical, physical, rheological, thermal, or processing properties of the base polymer composition. In the case of polycarbonate copolymers comprising structural units of DMBPC and DDDA, the minor forensic authentication marker is typically DDDA used at a level greater than or equal to 0.05 wt % in the final tagged polymer composition. Blends of two different forensic polymer compositions are also possible.

In another embodiment, the forensic polymer composition is an arylate polymer or copolymer comprising greater than or equal to about 5 mole % structural units of the formula (10)

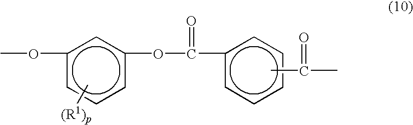

wherein each R₁ is a substituent, especially halo or C₁₋₁₂ alkyl, and p is 0-3.

In one embodiment, the arylate polymer useful as the forensic polymer composition also comprises structural units of the formula (11):

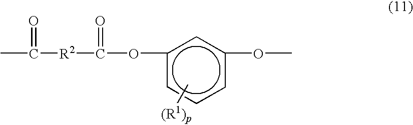

wherein R¹ and p are as previously defined and R² is a divalent C₄₋₁₂ aliphatic, alicyclic, or mixed aliphatic-alicyclic radical. The units of formula (11) contain a resorcinol or substituted resorcinol moiety in which any R¹ groups may be C₁₋₄ alkyl (i.e., methyl, ethyl, propyl, or butyl). In one embodiment R¹ groups are primary or secondary groups. In a particular embodiment R¹ groups are methyl. In some embodiments R¹ groups are resorcinol moieties, in which p is zero, although moieties in which p is 1 are also suitable for use herein. The resorcinol moieties are most often bound to isophthalate and/or terephthalate moieties. Arylate polymers useful as the copolymer are disclosed in U.S. Pat. No. 6,607,814. In one exemplary embodiment, the forensic authentication composition is a copolymer comprising 5 to 30 mole percent of structural units of formula (10) and 95 to 70 mole percent of structural units of formula (11), where the structural units of formulas (10) and (11) are the forensic authentication marker. In another exemplary embodiment, the forensic polymer composition is a copolymer comprising 10 to 20 mole percent structural units of formula (10) and 90 to 80 mole percent of structural units of formula (11), where the structural units of formulas (10) and (11) are the forensic authentication marker.

In yet another embodiment, the forensic authentication marker is the siloxane block of a polysiloxane containing block copolymer. Exemplary polysiloxane copolymers are those disclosed in U.S. Pat. Nos. 6,072,011, 5,530,083 and 5,616,674, such as polycarbonate blocks having recurring units of the structure (12):

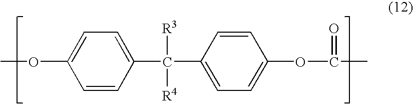

where R³ and R⁴ are each independently selected from hydrogen, hydrocarbyl or halogen-substituted hydrocarbyl, specifically methyl; and (2) polysiloxane blocks of the structure (13):

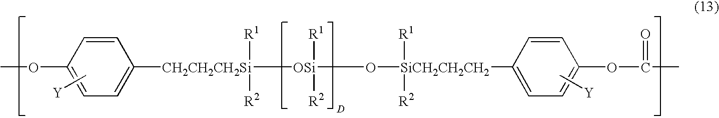

where R¹ and R² are each independently hydrogen, hydrocarbyl or halogen-substituted hydrocarbyl, in one exemplary embodiment R¹ is methyl and R² is methyl or phenyl, and where D is an integer of about 10 to about 120, specifically, about 10 to 50; and Y is hydrogen, hydrocarbyl, hydrocarbyloxy or halogen, in one exemplary embodiment methoxy; and where the weight percentage of blocks of structure (12) is about 98 to about 92.0% of the copolymers and the weight percentage of siloxane from the blocks of structure (13) is about 2 to about 8%.

The term “hydrocarbyl” as used herein with respect to polysiloxane containing block copolymers means the monovalent moiety obtained upon removal of a hydrogen atom from a parent hydrocarbon. Representative of hydrocarbyl are alkyl of 1 to 25 carbon atoms, inclusive such as methyl, ethyl, propyl, butyl, pentyl, hexyl, heptyl, octyl, nonyl, undecyl, decyl, dodecyl, octadecyl, nonodecyl eicosyl, heneicosyl, docosyl, tricosyl, tetracosyl, pentacosyl and the isomeric forms thereof, aryl of 6 to 25 carbon atoms, inclusive, such as phenyl, tolyl, xylyl, napthyl, biphenyl, tetraphenyl and the like; aralkyl of 7 to 25 carbon atoms, inclusive, such as benzyl, phenethyl, phenpropyl, phenbutyl, phenhexyl, napthoctyl and the like; cycloalkyl of 3 to 8 carbon atoms, inclusive, such as cyclopropyl, cyclobutyl, cyclopentyl, cyclohexyl, cycloheptyl, cyclooctyl, and the like.

The term “alkylene” as used herein with respect to polysiloxane containing block copolymers means the divalent moiety obtained on removal of two hydrogen atoms, each from a non-adjacent carbon atom of a parent hydrocarbon and includes alkylene of 3 to 15 carbon atoms, inclusive, such as 1,3-propylene, 1,4-butylene, 1,5-pentylene, 1,8-octylene, 1,10-decylene and the like.

Polysiloxane containing block copolymers suitable for use as the copolymer may be prepared by the reaction of a carbonate forming precursor, such as phosgene, with a bisphenol of the formula (14):

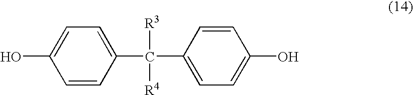

wherein R³ and R⁴ are as defined immediately above; and a siloxane diol of the structure depicted by the formula (15):

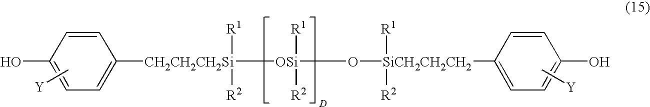

where R¹ and R², Y, and D are as defined above. In one exemplary embodiment, the species of the structures (15) is that in which R¹ and R² are methyl, Y is methoxy ortho to the phenolic hydroxyl, and D is about 10 to about 50. In one particularly exemplary embodiment, D will be from about 10 to about 25 for the species of structures (15) for optical media applications.

The bisphenol compounds of the formula (14) are represented by 2,2-bis-(4-hydroxyphenyl)propane (or bisphenol-A); 2,4′-dihydroxydiphenyl methane; bis-(2-hydroxyphenyl)methane; bis-(4-hydroxyphenyl)methane; bis-(4-hydroxy-5-nitrophenyl)methane; bis-(4-hydroxy-2,6-dimethyl-3-methoxyphenyl)methane; 1,1-bis-(4-hydroxyphenyl)ethane; 1,2-bis-(4-hydroxphenyl)ethane; 1,1-bis-(4-hydroxy-2-chlorophenyl)ethane; 1,1-bis-(2,5-dimethyl-4-hydroxyphenyl)ethane; 1,3-bis-(3-methyl-4-hydroxyphenyl)propane; 2,2-bis-(3-phenyl-4-hydroxyphenyl)propane; 2,2-bis-(3-isopropyl-4-hydroxyphenyl)propane; 2,2-bis-(4-hydroxyphenyl)propane; 2,2-bis-(4-hydroxyphenyl)pentane; 3,3-bis-(4-hydroxyphenyl)pentane; 2,2-bis-(4-hydroxyphenyl)heptane; bis-(4-hydroxyphenyl)phenylmethane; bis-(4-hydroxyphenyl)cyclohexymethane; 1,2-bis-(4-hydroxyphenyl)-1,2-bis-(phenyl)propane; 2,2-bis-(4-hydroxyphenyl)-1-phenylpropane; and the like.

The siloxane diols (15) depicted above as precursors of the siloxane block may be characterized as bisphenolsiloxanes. The preparation of these bisphenolsiloxanes is accomplished by the addition of a polydiorganosiloxane to a phenol containing an alkenyl substituent, according to the formula (16):

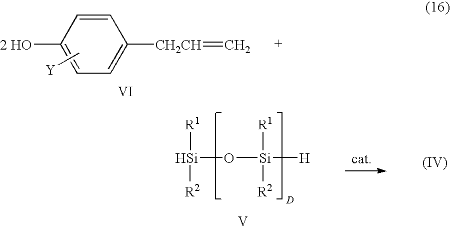

wherein R₁, R₂, Y, and D are as defined above.

In one embodiment, the forensic authentication marker is an end group attached to an oligomer or a polymer (also referred to as “end-cap”) that is typically obtained from a monophenol derivative such as p-cumylphenol as disclosed in U.S. Pat. No. 5,959,065. The role of these end groups is to terminate the polymer/copolymer chain and thus provide a polymer that is less likely to react with other species in the formulation. In an embodiment, the end group amounts to between about 0.2 to about 5 mole percent of the forensic polymer composition having the forensic authentication marker.

Examples of suitable end groups include p-cumylphenol as well as phenol p-cyanophenol, and p-t-butyl phenol, and mixtures of p-cumylphenol, cyanophenol phenol and/or para-tertiarybutyl phenol. In one embodiment, greater than or equal to about 50 weight percent of the endcapping group will be p-cumylphenol, while in another embodiment, the endcapping group will comprise greater than or equal to about 70 weight percent of the p-cumylphenol. In one exemplary embodiment, the endcapping group will consist of p-cumylphenol.

The forensic authentication marker is present in the forensic polymer composition in amount that when added to the base polymer composition, is detectable by a forensic analytical technique. For example, the forensic authentication marker is present in the tagged polymer composition in an amount of less than or equal to about 10.0 weight percent (wt %), specifically, less than or equal to about 5.0 wt %, more specifically, less than or equal to about 2.0 wt %, and yet more specifically, less than or equal to about 1.0 wt %, based on the total weight of the tagged polymer composition; e.g., about 0.002 wt % to about 10.0 wt %, based on the total weight of the tagged polymer composition, specifically about 0.05 wt % to about 5.0 wt %, more specifically about 0.01 wt % to about 1.0 wt %, and still more specifically about 0.1 wt % to about 1.0 wt %.

Forensic analytical techniques as used herein refer to analytical methods that are capable of detecting one or more forensic authentication markers that confirm the presence of the forensic authentication marker in the tagged polymer composition. Illustrative examples include resonance spectroscopy methods such as nuclear magnetic resonance (NMR) and electron spin resonance (ESR), x-ray photon electron spectroscopy-electron spectroscopy for chemical analysis (XPS-ESCA), energy dispersive x-ray spectroscopy (EDX) coupled to scanning electron microscopy (SEM-EDX), atomic absorption spectroscopy, gas or liquid chromatography (e.g., high performance liquid chromatography (HPLC)), and the like. In one exemplary embodiment the forensic analytical technique provides a determination of the structure of the forensic authentication marker as opposed to measuring a signal such as fluorescence or absorption. Such structural techniques include NMR, XPS-ESCA, HPLC, and ESR. In one exemplary embodiment, the forensic analytical technique is at least one of NMR, HPLC, or ESR. In one exemplary embodiment, the forensic analytical technique is NMR, specifically NMR having multinuclear capabilities, such as carbon NMR, proton NMR, fluorine NMR, silicon NMR, phosphorus NMR, nitrogen NMR, and the like. In one exemplary embodiment the NMR technique used as the forensic analytical technique is proton NMR. In another exemplary embodiment, the forensic analytical technique is gas or liquid chromatography. In yet another embodiment, the forensic analytical technique is high performance liquid chromatography (HPLC) with a detector such as an ultraviolet (UV) detector, fluorescence detector (FLD), mass spectrometric (MS) detector, refractive index (RI) detector, evaporative light scattering detector (ELSD), and the like. In still another embodiment, the forensic analytical technique is HPLC-UV. In still another embodiment, the forensic analytical technique is HPLC-FLD.

High performance liquid chromatography (HPLC) is a form of column chromatography with both a stationary phase and a mobile phase. A column holds chromatographic material, which comprises the stationary phase, while solvent flowing through the column comprises the mobile phase. The detector records the signal intensity as a function of time which can then be used to identify and quantify the materials (e.g., the forensic authentication marker) of interest by the signal intensity for any given retention time. The sample to be analyzed is introduced in small volume to the stream of mobile phase and is retarded by specific chemical or physical interactions with the stationary phase as it travels the length of the column. The amount of retardation depends upon the nature of the solvent used, the stationary phase composition, and the mobile phase composition. Retention time is defined as the time at which the material of interest elutes from the end of the column, starting when the sample is introduced to the column. Performing the analysis at high pressure causes the process to proceed more quickly, leading to improved resolution in the chromatogram.

In an embodiment, a sample is formed by combining a base polymer composition with a forensic polymer composition having a forensic authentication marker to form a tagged polymer composition sample. Then, in an embodiment, the tagged polymer composition sample containing the forensic authentication marker is reacted chemically by a process such acid hydrolysis, methanolysis, ammonolysis, or the like, which converts the high molecular weight forensic polymer composition sample to smaller compounds amenable to HPLC analysis. The resultant solution is injected onto the column and the specific forensic authentication marker is separated from the other compositions present in the sample in solution by liquid chromatography. The separated forensic authentication marker (e.g., monomer) is then detected using, for example, an in-line ultraviolet detector generally having a detection limit of 0.02 wt % of the forensic authentication marker or an in-line fluorescence detector generally having a detection limit of 0.002 wt % of the forensic authentication marker.

In another embodiment, a sample of a tagged polymer composition containing a forensic authentication marker (e.g., DMBPC structural units) is dissolved in a suitable solvent and then this tagged polymer composition sample is reacted with methanolic potassium hydroxide, sometimes referred to as methanolysis HPLC. For example, under appropriate conditions, a DMBPC copolymer is first converted at nearly 100% conversion to 1,1-bis(4-hydroxy-3-methylphenyl)cyclohexane (DMBPC) monomer, bisphenol A, and p-cumylphenol by treatment with methanolic potassium hydroxide and then quenching with acid. The resulting solution is then diluted and analyzed by HPLC. The amount of DMBPC monomer (i.e., forensic authentication marker) measured using methanolysis HPLC can accurately reflect the amount of forensic authentication marker present in the tagged polymer composition sample.

Tagged polymer compositions and tagged articles described herein comprise, in addition to the forensic authentication marker, a dynamic response authentication marker in the base polymer composition. Dynamic response authentication marker as used herein refers to spectroscopic tags, thermochromic compounds, and optically variable tags. Dynamic response authentication marker is a substance(s) that changes the mode(s) in which it represents itself. For example, in one embodiment, the dynamic response authentication marker can be a fluorophore added to the based polymer composition that absorbs light in the ultraviolet range of the electromagnetic spectrum, but changes modes when tested by a dynamic response analytical technique and emits in the visible light range. In another embodiment, the dynamic response authentication marker can be a thermochromic compound that has a first signal (e.g., a red color) at a first temperature and a second signal (e.g., a change in mode) at a second signal (e.g., a yellow color) at a second temperature. In still another embodiment, the dynamic response authentication marker can be an optically variable tag that has a fluorescence emission with a first peak position at a first time and a second peak position (e.g., a change in mode) at a second, later time, where the change in mode (i.e., from the first peak position to the second peak position) is identified, for example in terms of a shift from the first peak position.

Spectroscopic tags include organic fluorophores, inorganic fluorophores, organometallic fluorophores, luminescent nanoparticles, and combinations comprising at least one of the foregoing. Spectroscopic tags make it possible to determine thermal history and degradation of a polymer. In addition, the spectroscopic tags can be selected such that they are not sensitive to polymer additives and to chemical and physical aging of a polymer (e.g., the spectroscopic tags do not react with polymer additives or degrade due to chemical and/or physical aging of a polymer).

In one embodiment, for example when the base polymer composition is polycarbonate, these spectroscopic tagging materials are selected from classes of dyes that exhibit high robustness against ambient environmental conditions and temperature stability of greater than or equal to about 350° C., specifically greater than or equal to about 375° C., and more specifically greater than or equal to about 400° C. For some of the dynamic response authentication markers the excitation range is about 100 nanometers (nm) to about 1,100 nm, and more typically about 200 nm to about 1,000 nm, and most typically about 250 nm to about 950 nm. The emission range, which is different than the excitation range, is typically about 250 nm to about 2,500 nm. For example, the dynamic response authentication marker can have a maximum excitation in the UV range of 100 nm to 400 nm, specifically, 250 nm to 400 nm, more specifically, 300 nm to 400 nm, even more specifically, 320 nm to 400 nm, and still more specifically 330 nm to 390 nm.

The dynamic response authentication marker can, for example, have a maximum fluorescence emission in the visible range of 400 nm to 800 nm, specifically, 450 nm to 750 nm, more specifically, 480 nm to 670 nm, even more specifically 570 nm to 670 nm or 480 nm to 570 nm.

In one embodiment, the dynamic response authentication marker can be a fluorophore that absorbs in the UV range and emits in the visible light range. In one exemplary embodiment, the dynamic response authentication marker can be a long stokes shift UV fluorophore dye. “Stokes shift” as used herein refers to the distance between the maximum excitation or absorption and the maximum emission at fluorescence. Materials are generally referred to as “long Stokes shift” materials when the Stokes shift is greater than or equal to about 50 nm. For example, the dynamic response authentication marker can have a long stokes shift of greater than or equal to about 50 nm, specifically greater than or equal to about 100 nm, more specifically greater than or equal to about 150 nm, and even more specifically greater than or equal to about 200 nm.

For example, the dynamic response authentication marker can have a long stokes shift of about 75 nm to about 250 nm, specifically, about 100 nm to 175 nm. Exemplary commercially available dynamic response authentication markers include green, yellow, orange, and red emitting UV fluorophores from the Lumilux CD pigment series produced by Honeywell of Seelze, Germany. In the case of optical media applications, it is important to select the fluorophore so that it does not impact playability. This generally implies that the fluorophore needs to be soluble in the base polymer composition of the optical media substrate or dispersed in domains that will not scatter light If the refractive index of the fluorophore is close to the refractive index of the base polymer composition, larger particles may be used provided that the manufacturing process of the tagged polymer composition does not generate aggregates that scatter light. Unacceptable levels of scattering can be determined by measurement of haze as per ASTM D1003. Generally, a haze value of less than about 1% at 3.2 mm is considered acceptable for optical media applications.

The spectroscopic tags useful as dynamic response authentication markers include organic, inorganic, or organometallic fluorophores. Exemplary fluorophores include, but are not limited to, known dyes such as polyazaindacenes or coumarins, including those set forth in U.S. Pat. No. 5,573,909. Other possibly useful families of dyes include lanthanide complexes, hydrocarbon and substituted hydrocarbon dyes; polycyclic aromatic hydrocarbons; scintillation dyes (specifically oxazoles and oxadiazoles); aryl- and heteroaryl-substituted polyolefins (C₂-C₈ olefin portion); carbocyanine dyes; phthalocyanine dyes and pigments; oxazine dyes; carbostyryl dyes; porphyrin dyes; acridine dyes; anthraquinone dyes; anthrapyridone dyes; arylmethane dyes; azo dyes; diazonium dyes; nitro dyes; quinone imine dyes; tetrazolium dyes; thiazole dyes; perylene dyes; perinone dyes; bis-benzoxazolylthiophene (BBOT); naphthalimide dyes; benzimidazole dyes; indigoid or thioindigoid dyes; and xanthene or thioxanthene dyes. Fluorophores also include anti-stokes shift dyes which absorb in the near infrared wavelength and emit in the visible wavelength.

The following is a partial list of commercially available, possibly suitable luminescent dyes: 5-Amino-9-diethyliminobenzo(a)phenoxazonium Perchlorate 7-Amino-4-methylcarbostyryl, 7-Amino-4-methylcoumarin, 7-Amino-4-trifluoromethylcoumarin, 3-(2′-Benzimidazolyl)-7-N,N-diethylaminocoumarin, 3-(2′-Benzothiazolyl)-7-diethylaminocoumarin, 2-(4-Biphenylyl)-5-(4-t-butylphenyl)-1,3,4-oxadiazole, 2-(4-Biphenylyl)-5-phenyl-1,3,4-oxadiazole, 2-(4-Biphenyl)-6-phenylbenzoxazole-1,3,2,5-Bis-(4-biphenylyl)-1,3,4-oxadiazole, 2,5-Bis-(4-biphenylyl)-oxazole, 4,4′-Bis-(2-butyloctyloxy)-p-quaterphenyl, p-Bis(o-methylstyryl)-benzene, 5,9-Diaminobenzo(a)phenoxazonium Perchlorate, 4-Dicyanomethylene-2-methyl-6-(p-dimethylaminostyryl)-4H-pyran, 1,1′-Diethyl-2,2′-carbocyanine Iodide, 1,1′-Diethyl-4,4′-carbocyanine Iodide, 3,3′-Diethyl-4,4′,5,5′-dibenzothiatricarbocyanine Iodide, 1,1′-Diethyl-4,4′-dicarbocyanine Iodide, 1,1′-Diethyl-2,2′-dicarbocyanine Iodide, 3,3′-Diethyl-9,11-neopentylenethiatricarbocyanine Iodide, 1,3′-Diethyl-4,2′-quinolyloxacarbocyanine Iodide, 1,3′-Diethyl-4,2′-quinolylthiacarbocyanine Iodide, 3-Diethylamino-7-diethyliminophenoxazonium Perchlorate, 7-Diethylamino-4-methylcoumarin, 7-Diethylamino-4-trifluoromethylcoumarin, 7-Diethylaminocoumarin, 3,3′-Diethyloxadicarbocyanine Iodide, 3,3′-Diethylthiacarbocyanine Iodide, 3,3′-Diethylthiadicarbocyanine Iodide, 3,3′-Diethylthiatricarbocyanine Iodide, 4,6-Dimethyl-7-ethylaminocoumarin, 2,2′-Dimethyl-p-quaterphenyl, 2,2-Dimethyl-p-terphenyl, 7-Dimethylamino-1-methyl-4-methoxy-8-azaquinolone-2,7-Dimethylamino-4-methylquinolone-2,7-Dimethylamino-4-trifluoromethylcoumarin, 2-(4-(4-Dimethylaminophenyl)-1,3-butadienyl)-3-ethylbenzothiazolium Perchlorate, 2-(6-(p-Dimethylaminophenyl)-2,4-neopentylene-1,3,5-hexatrienyl)-3-methylbe-nzothiazolium Perchlorate, 2-(4-(p-Dimethylaminophenyl)-1,3-butadienyl)-1,3,3-trimethyl-3H-indolium Perchlorate, 3,3′-Dimethyloxatricarbocyanine Iodide, 2,5-Diphenylfuran, 2,5-Diphenyloxazole, 4,4′-Diphenylstilbene, 1-Ethyl-4-(4-(p-Dimethylaminophenyl)-1,3-butadienyl)-pyridinium Perchlorate, 1-Ethyl-2-(4-(p-Dimethylaminophenyl)-1,3-butadienyl)-pyridinium Perchlorate, 1-Ethyl-4-(4-(p-Dimethylaminophenyl)-1,3-butadienyl)-quinolium Perchlorate, 3-Ethylamino-7-ethylimino-2,8-dimethylphenoxazin-5-ium Perchlorate, 9-Ethylamino-5-ethylamino-10-methyl-5H-benzo(a)phenoxazonium Perchlorate, 7-Ethylamino-6-methyl-4-trifluoromethylcoumarin, 7-Ethylamino-4-trifluoromethylcoumarin, 1,1′,3,3,3′,3′-Hexamethyl-4,4′,5,5′-dibenzo-2,2′-indotricarboccyanine Iodide, 1,1′,3,3,3′,3′-Hexamethylindodicarbocyanine Iodide, 1,1′,3,3,3′,3′-Hexamethylindotricarbocyanine Iodide, 2-Methyl-5-t-butyl-p-quaterphenyl, N-Methyl-4-trifluoromethylpiperidino-<3,2-g>coumarin, 3-(2′-N-Methylbenzimidazolyl)-7-N,N-diethylaminocoumarin, 2-(1-Naphthyl)-5-phenyloxazole, 2,2′-p-Phenylen-bis(5-phenyloxazole), 3,5,3″″,5″″-Tetra-t-butyl-p-sexiphenyl, 3,5,3″″,5″″-Tetra-t-butyl-p-quinquephenyl, 2,3,5,6-1H,4H-Tetrahydro-9-acetylquinolizino-<9,9a, 1-gh>coumarin, 2,3,5,6-1H,4H-Tetrahydro-9-carboethoxyquinolizino-<9,9a,1-gh>coumarin, 2,3,5,6-1H,4H-Tetrahydro-8-methylquinolizino-<9,9a,1-gh>coumarin, 2,3,5,6-1H,4H-Tetrahydro-9-(3-pyridyl)-quinolizino-<9,9a,1-gh>coumarin, 2,3,5,6-1H,4H-Tetrahydro-8-trifluoromethylquinolizino-<9,9a,1-gh>coumarin, 2,3,5,6-1H,4H-Tetrahydroquinolizino-<9,9a,1-gh>coumarin, 3,3′,2″,3′″-Tetramethyl-p-quaterphenyl, 2,5,2″″,5′″-Tetramethyl-p-quinquephenyl, P-terphenyl, P-quaterphenyl, Nile Red, Rhodamine 700, Oxazine 750, Rhodamine 800, IR 125, IR 144, IR 140, IR 132, IR 26, IR5, Diphenylhexatriene, Diphenylbutadiene, Tetraphenylbutadiene, Naphthalene, Anthracene, 9,10-diphenylanthracene, Pyrene, Chrysene, Rubrene, Coronene, Phenanthrene, anthrapyridones, and naphtamimide.

Spectroscopic tags useful as dynamic response authentication markers may also include luminescent nanoparticles of sizes from about 1 nanometer to about 50 nanometers. Exemplary luminescent nanoparticles include, but are not limited to, semi-conducting nanoparticles of CdS, ZnS, Cd₃ P₂, PbS, or combinations comprising at least one of the foregoing. Other luminescent nanoparticles also include rare earth aluminates or silicates including, but not limited to, strontium aluminates doped with Europium and Dysprosium.

In one embodiment, spectroscopic tagging materials such as perylenes (such as Anthra[2,1,9-def:6,5,10-d′e′f′]diisoquinoline-1,3,8,10(2H,9H)-tetrone, 2,9-bis[2,6-bis(1-methyethyl)phenyl]-5,6,12,13-tetraphenoxy) are utilized as the dynamic response authentication markers.

In another embodiment, the dynamic response markers are thermochromic compounds. The term ‘thermochromic compounds’ generally refers to compounds that change color as a function of temperature. ‘Thermochromic compounds’ as used herein refers to compounds that when exposed to electromagnetic radiation of a particular wavelength, have a first signal at a first temperature, and a second signal at a second temperature, the second temperature being greater than the first temperature and the first and second signals being different (e.g., the first signal can be a red color at the first temperature and the second signal can be a yellow color at a second temperature). The first temperature is sometimes referred to as the ‘cold’ state and the second temperature as the ‘hot’ state.

‘Signal’ as Used Herein for Dynamic Authentication Markers Refers to a response detectable by an analytical method such as vibrational spectroscopy, fluorescence spectroscopy, luminescence spectroscopy, electronic spectroscopy, and the like, and combinations comprising at least one of the foregoing. Examples of vibrational spectroscopies are Raman, infrared, Surface Enhanced Raman, and Surface Enhanced Resonance Raman spectroscopies. In one exemplary embodiment, signal refers to a response detectable by an analytical method such as fluorescence spectroscopy, luminescence spectroscopy, and the like, and combinations comprising at least one of the foregoing. In another exemplary embodiment, signal refers to a response detectable by fluorescence spectroscopy.

In one embodiment, the signal of the thermochromic compound reflects changes in the fluorescence or luminescence of the thermochromic compound. The changes in fluorescence emission can be detected by observing changes in the complete emission spectrum or changes in local parts of the spectrum (i.e. by looking at the discrete intensity of the fluorescence emission at the peak location of the tag emission or by looking at ratios of fluorescence intensity at selected wavelengths that are known to exhibit different values in the “hot” and “cold” state). For example, in one embodiment, the signal is the intensity or location of the fluorescence emitted at a particular excitation wavelength or range. In one exemplary embodiment, the signal of the thermochromic compound is evaluated as the fluorescence emitted by a tagged polymer at a particular excitation wavelength, i.e., the authentication wavelength as discussed below. In one embodiment, the fluorescence intensity changes over time in response to a heat pulse can be used as a signal.

In one exemplary embodiment the first and second signals of the thermochromic compound are different by at least about 5%, based on the fluorescence intensity or ratio of fluorescence intensity of the thermochromic compound. In another embodiment, the first and second signals of the thermochromic compound are different by at least about 10 nm, based on the fluorescence peak location of the thermochromic compound.

Suitable thermochromic compounds for use in the tagged polymer composition and tagged articles include organic materials selected to be chemically compatible with the substrate polymer and have a heat stability consistent with engineering plastics compounding and in particular with the processing conditions of the base polymer. In one embodiment, the stable thermochromic compounds can be conjugated polymers containing aromatic and/or heteroatomic units exhibiting thermochromic properties.

Illustrative examples of suitable thermochromic Compounds include Poly(3-alkylthiophene)s, poly(3,4-alkylenedioxythiophene)s, alkyl/aryl substituted poly(isothianaphtenes)s and corresponding copolymers, blends, or combinations of the corresponding monomers.

In one embodiment, the polythiophene is generally of the formula (17):

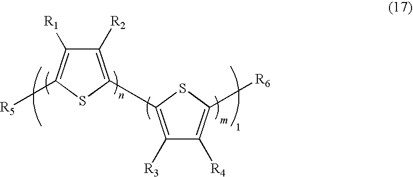

wherein R¹-R⁶ is a hydrogen, substituted or unsubstituted alkyl radical, substituted or unsubstituted alkoxy radical, substituted or unsubstituted aryl radical, substituted or unsubstituted thioalkyl radical, substituted or unsubstituted trialkylsilyl radical, substituted or unsubstituted acyl radical, substituted or unsubstituted ester radical, substituted or unsubstituted amine radical, substituted or unsubstituted amide radical, substituted or unsubstituted heteroaryl or substituted or unsubstituted aryl radical, n is between 1 and 1,000, m is between 0 and 1,000, and 1 is between 1 and 1,000. In another embodiment, R¹-R² or R³-R⁴ comprise a 5 or 6 membered ring. In another embodiment, R¹-R² or R³-R⁴ comprise a ring with 6 or more members. In yet another embodiment, R²-R³ are bridged forming a ring with 6 or more members.

In synthesizing a polythiophene for a specific design temperature, e.g. for the series of poly(3-alkylthiophene)s, there is roughly an inverse correlation with the length of the n-alkane substituent and the temperature of the thermochromic transition for both the regiorandom (R¹=alkyl, R⁴=alkyl, n≅0.8, m≅0.2, l=40-80, R², R³, R⁵, R⁶═H) and regioregular (R¹=alkyl, n=40-80, m=0, R², R⁵, R⁶═H), poly(3-n-alkylthiophene)s. For regiorandom polymers longer substituents such as n-hexadecyl have lower temperature thermochromic transitions (81° C.) than shorter chain substituents such as n-octyl (130° C.). The regioregular polymers have higher thermochromic transitions than the regiorandom polymers but the same inverse correlation with chainlength is observed. The n-hexadecyl and n-octyl have thermochromic transition from about 125° C. to about 175° C. As long as the number of thiophene units in the polymer is approximately greater than sixteen, the thermochromic transition is molecular weight independent. Oligothiophenes (n+m+1<16) have lower temperature thermochromic transitions than the polythiophenes (n+m+1>16).

In one exemplary embodiment, the thermochromic compound is a regiorandom polymer. In one exemplary embodiment, the thermochromic compound is a regiorandom polymer in the poly(3-alkylthiophene) series. In another exemplary embodiment, the thermochromic compound is an oligothiophene wherein (n+m+1<16).

In one embodiment, the thermochromic compound utilized as a dynamic response authentication marker is a thermochromic compound having a thermochromic transition temperature of greater than or equal to about 30° C. In one embodiment, the thermochromic compound utilized is a thermochromic compound having a thermochromic transition temperature of less than or equal to about 250° C. In another embodiment, the thermochromic compound utilized is a thermochromic compound having a thermochromic transition temperature of about 35° C. to about 195° C., specifically about 45° C. to about 135° C.

In another embodiment, the dynamic response authentication marker is an optically variable tag. Suitable optically variable tags for use in the disclosed methods include fluorescent or luminescent materials that are selected to be chemically compatible with the base polymer composition and have a heat stability consistent with engineering plastics compounding and in particular with the processing conditions of the base polymer. In one embodiment, the optically variable tags are selected for their relatively good heat stability and compatibility with polycarbonate. In one embodiment, the optically variable tag is added to the base polymer composition in an amount sufficient to be detected by fluorescence spectroscopy.

In one embodiment, the stable optically variable tags are at least one of oxadiazole derivatives or luminescent conjugated polymers. Illustrative examples of suitable luminescent conjugated polymers are blue emitting luminescent polymers, such as poly-paraphenylenevinylene derivatives. Illustrative examples of suitable oxadiazole derivatives include oxadiazole derivatives substituted with a biphenyl or substituted biphenyl in the 2-position and with a phenyl derivative in the 5-position.

In one exemplary embodiment, the optically variable tag is one of tert-butyl phenyl oxadiazole, bis(Biphenylyl) oxadiazole, or a mixture of tert-butyl phenyl oxadiazole and bis(Biphenylyl) oxadiazole. In one exemplary embodiment, the optically variable tag is tert-butyl phenyl oxadiazole. In another exemplary embodiment, the optically variable tag is bis(Biphenylyl) oxadiazole.

Optically variable tags suitable for use as dynamic response authentication markers can have a fluorescence emission whose wavelength and intensity change over time.

In one embodiment, the optically variable tag has a fluorescence emission characterized by a first peak position at an initial time and a second peak position at a second, later time. The second peak position may generally be identified in terms of the shift from the first peak position. In another embodiment, the first peak position of the fluorescence emission is at about 160 nm to about 1,100 nm, while the other peak position of the fluorescence emission is shifted from the first peak by about 2 nm to about 300 nm. In one exemplary embodiment, a first peak is at about 250 nm to about 750 nm, while the second peak is shifted by about 5 nm to about 200 nm. In another exemplary embodiment, the first peak is at about 300 nm to about 700 nm, while the second peak is shifted by about 10 nm to about 100 nm.

In another embodiment, the tagged polymer compositions containing the optically variable tags disclosed herein are identified via an authenticating signal that is the predetermined change of the fluorescence ratio of emission intensities at two or more pre-selected wavelengths. These pre-selected wavelengths are selected so that the fluorescence ratio of a polymer without the optically variable tags changes in one direction, normally a decrease, while the fluorescence ratio of a tagged polymer comprising the optically variable tags changes in the opposite direction, i.e., normally an increase.

Pre-selected wavelengths are selected as the maximum fluorescence emission. Typically, the first pre-selected wavelength corresponds to the first peak emission while the second pre-selected wavelength corresponds to the second peak emission. In one embodiment, the pre-selected wavelength is about 160 to about 1,100 nm. In one exemplary embodiment, one pre-selected wavelength is selected at a wavelength within +/−10 nm of the maximum peak emission. In another embodiment, the pre-selected wavelength is selected within +/−30 nm of the maximum peak emission. In yet another embodiment, the pre-selected wavelength is selected within +/−50 nm of the maximum peak emission. In one exemplary embodiment, at least one of the pre-selected wavelengths is in the range of about 300 nm to about 400 nm.

In one embodiment, the ratio of the fluorescence intensities changes during the authentication process by greater than or equal to 5% as compared to the original or initial fluorescence ratio. That is, the ratio of fluorescence intensities exhibits an increase or decrease of 5% as compared to the original or initial value. In another embodiment, the change is greater than or equal to about +/−25%. In yet another embodiment, the change is greater than or equal to about +/−95%. In yet another embodiment, the change in fluorescence ratio is between about 5% and about 200%.

In addition, the authenticating signal of the tagged polymer compositions containing the optically variable tags may also be the changing intensity of the fluorescence emission of the optically variable tag.

The changes in fluorescence emission can be detected by observing changes in the complete emission spectrum or changes in local parts of the spectrum (i.e., by looking at the discrete intensity of the fluorescence emission at the peak location of the tag emission) over time.

In one exemplary embodiment the change in intensity is evaluated over time as a function of the difference between intensity at a time T1 and a time T2, T2 being greater than T1. In one embodiment, there is a difference of greater than or equal to about 10% between the signals at T1 and T2. In one embodiment where the authenticating signal is repeatable, the difference between the signals at T1 and T2 is about 10% to about 90%, specifically about 15% to about 75%, more specifically about 20% to about 40%. In another embodiment where the authenticating signal is not repeatable, the difference between the signals at T1 and T2 is about 10% to 100%.

Non-optically variable compounds may optionally be used in the tagged polymers disclosed herein. In one exemplary embodiment, the non-optically variable compounds are fluorescent tags that are selected to enhance the signal from optically variable tags. Fluorescent tags as used herein refers to at least one of an organic fluorophore, an inorganic fluorophore, an organometallic fluorophore, a semiconducting luminescent nanoparticle, or combinations comprising at least one of the foregoing. In addition, the fluorescent tags used are insensitive to polymer additives and to chemical and physical aging of the polymer.

In one exemplary embodiment, the fluorescent tags are selected from classes of dyes that exhibit high robustness against ambient environmental conditions and temperature stability of greater than or equal to about 350° C., specifically greater than or equal to about 375° C., and more specifically greater than or equal to about 400° C. Typically, the fluorescent tags have temperature stability for a time period greater than or equal to about 20 seconds. In one embodiment, the fluorescent tags have a temperature stability for a time period greater than or equal to about 1 minute, specifically greater than or equal to about 5 minutes, more specifically greater than or equal to about 10 minutes.

The concentration of the dynamic response authentication marker depends on the quantum efficiency of the tagging material, excitation and emission wavelengths, and employed detection techniques. In some embodiments, the concentration can be about 10⁻⁵ wt % to about 1 wt % of the tagged polymer composition, more specifically about 10⁻⁴ wt % to about 0.5 wt % of the tagged polymer composition, and even more specifically about 10⁻³ wt % to about 0.25 wt % of the tagged polymer composition. In one exemplary embodiment, the concentration of the dynamic response authentication marker can be about 10⁻⁴ wt % to about 0.1 wt % of the tagged polymer composition. In yet another exemplary embodiment, the concentration can be about 10⁻⁵ wt % to about 0.1 wt % of the tagged polymer composition.

Dynamic response analytical technique as used herein refers includes fluorescence spectroscopy, luminescence spectroscopy, electronic spectroscopy, vibrational spectroscopy, color spectrophotometry, visual observation under specific lighting conditions, and combinations comprising at least one of the foregoing. In one embodiment, the dynamic response analytical technique includes luminescence spectroscopy, fluorescence spectroscopy, visual observation under specific lighting conditions, while in another exemplary embodiment, the dynamic response analytical technique includes electronic spectroscopy, color spectrophotometry and vibrational spectroscopy.

The tagged polymer composition can be produced in one embodiment by using a reaction vessel capable of adequately mixing various precursors, such as a single or twin-screw extruder, kneader, blender, or the like.

Methods for incorporating together a base polymer, a forensic authentication and a dynamic response authentication marker include, for example, compounding, solution casting, admixing, blending, or copolymerization. The forensic authentication markers and dynamic response authentication markers can be added to the polymer such that they are uniformly dispersed throughout the tagged polymer or such that they are dispersed on a portion of the tagged polymer.

In another embodiment, the forensic authentication markers and dynamic response authentication markers are added to the base polymer composition in the polymer manufacturing stage, during polymer processing into articles, or combinations comprising at least one of the foregoing. It is possible to incorporate both types of authentication markers simultaneously or separately.

For example, the polymer precursors for the base polymer composition can be premixed with the forensic authentication marker(s) and the dynamic response authentication marker(s) (e.g., in a pellet, powder, and/or liquid form) and simultaneously fed into the extruder, or the forensic authentication marker(s) and the dynamic response authentication marker(s) can be optionally added in the feed throat or through an alternate injection port of the injection molding machine or other molding. Optionally, the base polymer composition can be produced and the forensic authentication marker(s) and the dynamic response authentication marker(s) can be dispersed on a portion of the base polymer composition.

In one embodiment, the forensic authentication marker(s) are incorporated into the base polymer composition specifically by copolymerization.

In one embodiment, the dynamic response authentication markers can be added to the base polymer composition by compounding, admixing, blending or copolymerization, specifically by compounding. In some embodiments, the tagged polymer composition contains more than one forensic authentication marker and/or more than one dynamic response authentication marker.

In another embodiment, the forensic authentication marker(s) and the dynamic response authentication marker(s) are added to the base polymer composition by compounding. In another exemplary embodiment, the dynamic response authentication marker(s) is first compounded with the forensic polymer composition to form a masterbatch (or concentrate). The masterbatch is then fed to the extruder for incorporation with the base polymer composition during the compounding step of the tagged polymer composition.

The extruder should be maintained at a sufficiently high temperature to melt the polymer precursors without causing decomposition thereof. For polycarbonate, for example, temperatures of about 220° C. to about 360° C. can be used, with about 260° C. to about 320° C. being used in one exemplary embodiment. Similarly, the residence time in the extruder should be controlled to minimize decomposition. Residence times of up to about 10 minutes or more can be employed, with up to about 5 minutes being used in one embodiment, up to about 2 minutes being used in another exemplary embodiment, and up to about 1 minute being employed in one exemplary embodiment. Prior to extrusion into the desired form (typically pellets, sheet, web, or the like), the mixture can optionally be filtered, such as by melt filtering and/or the use of a screen pack, or the like, to remove undesirable contaminants or decomposition products.

The tagged polymer compositions may be used for any application in which the physical and chemical properties of the material are desired and can be used to provide a variety of tagged articles, i.e., polymer based or polymer containing articles that utilize the tagged polymer composition. In a specific embodiment, the tagged polymer compositions are used for data storage media. After the tagged polymer composition has been produced, it can be formed into a data storage media using various molding techniques, processing techniques, or combination comprising at least one of the foregoing. Possible molding techniques include injection molding, film casting, extrusion, press molding, blow molding, stamping, and the like.

One possible process for making tagged articles comprises an injection molding-compression technique where a mold is filled with a molten tagged polymer composition to form an article. The mold may contain a preform, inserts, fillers, etc. The tagged polymer composition is cooled and, while still in an at least partially molten state, compressed to imprint the desired surface features (e.g., pits, grooves, edge features, smoothness, and the like), arranged in spiral concentric or other orientation, onto the desired portion(s) of the article, i.e. one or both sides in the desired areas. The article is then cooled to room temperature. Once the article has been produced, additional processing, such as electroplating, coating techniques (spin coating, spray coating, vapor deposition, screen printing, painting, dipping, and the like), lamination, sputtering, and combinations comprising one of the foregoing processing techniques, among others, may be employed to dispose desired layers on the article.

An example of a polycarbonate data storage media comprises an injection molded polycarbonate article that may optionally comprise a hollow (bubbles, cavity, and the like) or filled (metal, plastics, glass, ceramic, and the like, in various forms such as fibers, spheres, particles, and the like) core.

In one embodiment when a tagged polymer composition is formed into an article such as data storage media, the tagged polymer composition can be used to form article(s) (i.e., an optical media disk substrate) that will be read through by a laser in a data storage media player device. It is significantly more difficult to fake the response of a tagged polymer composition and ensure that the technology used does not impact playability of the media. In a data storage media having more than one substrate, such as a DVD, one or more of the substrates can be formed using the tagged polymer compositions. In one exemplary embodiment, a substrate of a DVD formed from the tagged polymer composition is the substrate layer read by a laser in a DVD media player device (i.e., the read side of the substrate).

Optical media may include, but is not limited to, any conventional pre-recorded, re-writable, or recordable formats such as: CD, CD-R, CD-RW, DVD, DVD-R, DVD-RW, DVD+RW, DVD-RAM, high-density DVD, magneto-optical, and others. It is understood that the form of the media is not limited to disk-shape, but may be any shape which can be accommodated in a readout device.

The tagged polymer may be used on either side of the data storage media substrate but in one exemplary embodiment, the tagged polymer can be employed in the read side because it is more technically challenging to develop tagged polymers that do not impact playability. In another exemplary embodiment, when the article is a DVD, it is desirable to use tagged polymers in both substrates. The tagged polymers can be either the same or different, but in one exemplary embodiment they are different and they provide different authenticating information.

### EXAMPLES

### Example 1

An illustrative polycarbonate composition having both forensic and dynamic response authentication markers is given in Table 1. In this particular example, polycarbonate with an average molecular weight of 17,700 units is used as the base polymer composition and a copolymer composed of Dimethyl Bisphenol Cyclohexane (DMBPC) and Bisphenol-A based polycarbonate is used as the forensic polymer composition with the DMBPC structural units as the forensic authentication marker. A UV-excitable long Stokes shift fluorophore emitting in the green region of the electromagnetic spectrum was obtained from Honeywell (Seelze, Germany) and used as the dynamic response authentication marker.

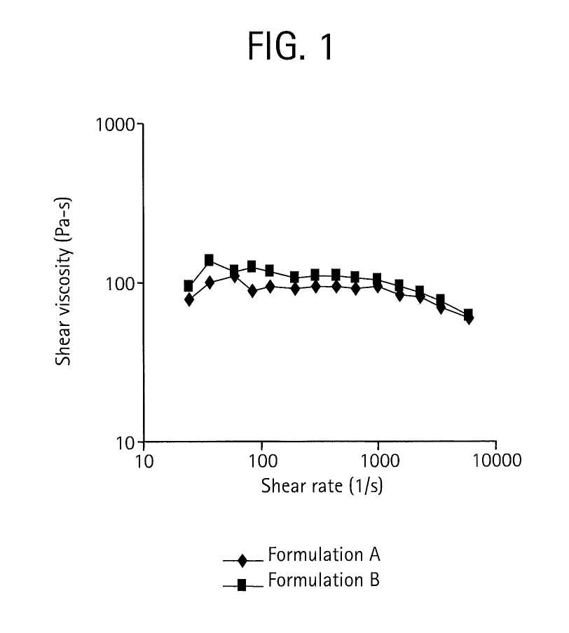

Samples A and B were extruded on a 30 mm twin-screw extruder at a melt temperature of 290° C. The pellets were then molded into color plaques having step thicknesses of 0.6 mm and 1.2 mm. Shear viscosity versus shear rate curves were generated to compare the flow behavior of the two formulations. All rheological data were measured at 300° C. on a capillary rheometer and are set forth in a graphical representation of shear viscosity versus shear rate in FIG. 1. The viscosities of the two materials overlap and shear thinning onsets at the same shear rate indicating that the addition of forensic and dynamic response authentication markers does not affect material properties of the polycarbonate. The same conclusion can be drawn from the fact that the melt flow of the two formulations differs by less than or equal to about 7% which does not correspond to a significant difference: melt volume rate of Sample A at 250° C. (ASTM D1238)=9.72 g/10 min; melt volume rate of Sample B at 250° C. (ASTM D1238)=10.39 g/10 min.

TABLE 1
Composition of formulation used in multilevel tagging system

| | Sample A | Sample B |
|---|---|---|
| | (parts by | (parts by |
| Components | weight) | weight) |
| Polycarbonate resin (average molecular | 100 | 90 |
| weight Mw of 17,700 determined by | | |
| Gel Permeation Chromatography (GPC) | | |
| against absolute PC standards) | | |
| Forensic polymer composition | | 10 (2.5 of the |
| DMBPC-BPA PC copolymer (25% DMBPC) | | forensic |
| (average Mw of 18,700) | | marker) |
| Glycerol monostearate (Riken Vitamin Co.) | 0.03 | 0.03 |
| Bis(2,4-dicumylphenyl)pentaerythritol | 0.02 | 0.02 |
| diphosphite (Dover Chemical Corporation) | | |
| Green emitting long Stokes shift UV | | 0.05 |
| fluorophore dye | | |
| yellow methine dye | 0.07 | 0.07 |
| orange methine dye | 0.0066 | 0.0066 |

### Example 2

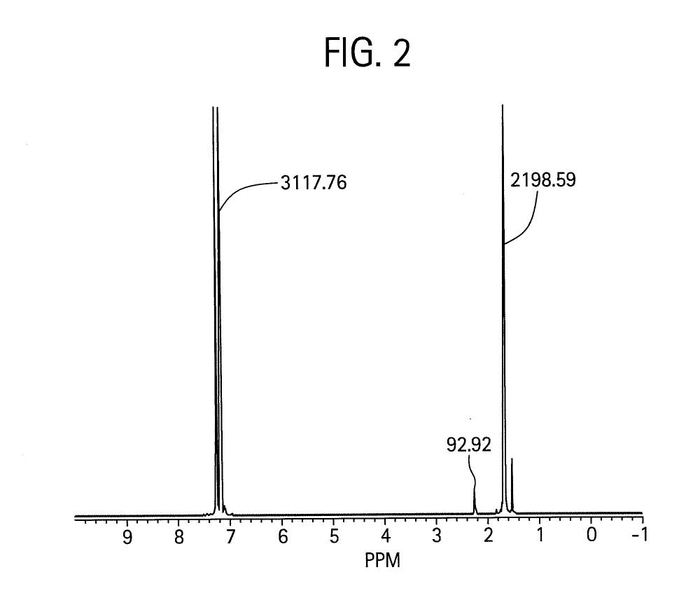

The results of an identification of forensic authentication markers according to the disclosed methods are set forth in FIG. 2. Solution state proton nuclear magnetic resonance (NMR) spectroscopy was used to quantify the type and quantity of the forensic authentication marker of Sample B, i.e. DMBPC structural units. Pellet samples were dissolved in approximately 1.5 ml of deuterated chloroform (99% purity) and then analyzed by a Varian Mercury-400 spectrometer.

The characteristic peaks attributable to the methyl groups on the DMBPC species (i.e., the structural units) were then mathematically analyzed and the concentration was determined to be approximately 2.5 wt %. This is in line with the value originally targeted by using a 25 wt % DMBPC-BPA copolymer at 10% loading in Sample B. The chosen value for the loading was for illustrative purposes only. From a practical point of view, the minimum possible loading that can give distinct spectral determination would be used. This however depends on the type of forensic authentication marker as well as the forensic analytical technique used in the disclosed method.

### Example 3

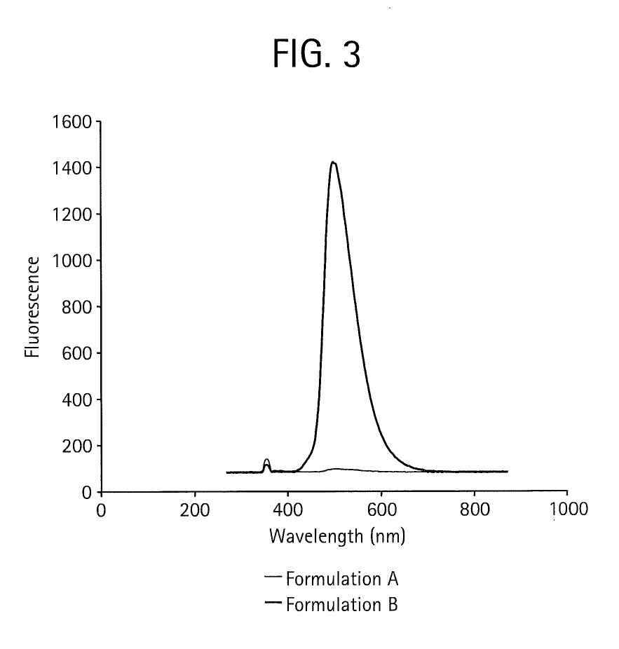

The results of an identification of dynamic response authentication markers according to the disclosed methods are set forth in FIG. 3. Fluorescence emission spectra of a UV fluorophore were measured on a setup, which included a miniature laser light source (Nanolase, France, 355 nm emission wavelength) and a portable spectrofluorometer (Ocean Optics, Inc., Dunedin, Fla., Model ST2000). The spectrofluorometer was equipped with a 200-μm slit, 600-grooves/mm grating blazed at 400 nm and covering the spectral range from 250 to 800 nm with efficiency greater than 30%, and a linear CCD-array detector. Light from the laser was focused into one of the arms of a “six-around-one” bifurcated fiber-optic reflection probe (Ocean Optics, Inc., Model R400-7-UV/VIS). Light from the samples was collected when the common end of the fiber-optic probe was positioned near the samples at a certain angle to minimize the amount of light directly reflected from the sample back into the probe. The second arm of the probe was coupled to the spectrofluorometer. FIG. 3 clearly shows the fluorescent emission of the long Stokes shift UV fluorophore incorporated in Formulation B versus the flat spectrum of Formulation A.

Color (CIE Lab color space) and transmission values (% T) were measured on the color plaques in transmission mode using a MacBeth Coloreye 7000A spectrophotometer under D65 illuminant and a 10-degree observer. Comparative color and transmission values for Formulations A and B in 0.6 mm are set forth below in Table 2.

TABLE 2
Comparative color and transmission values of Samples A and B in 0.6 mm

| | Color Data | | | | | |
|---|---|---|---|---|---|---|
| | (CIELab system) D65, | | | | | |
| | 10° observer | | | | % T@ 650 | % T@ 780 |
| | L* | a* | b* | ΔE | nm (0.6 mm) | nm (0.6 mm) |
| Formulation A | 88.79 | −4.78 | 102.10 | | 90.20 | 90.34 |
| Formulation B | 89.50 | −6.80 | 100.78 | 2.5 | 90.25 | 90.34 |

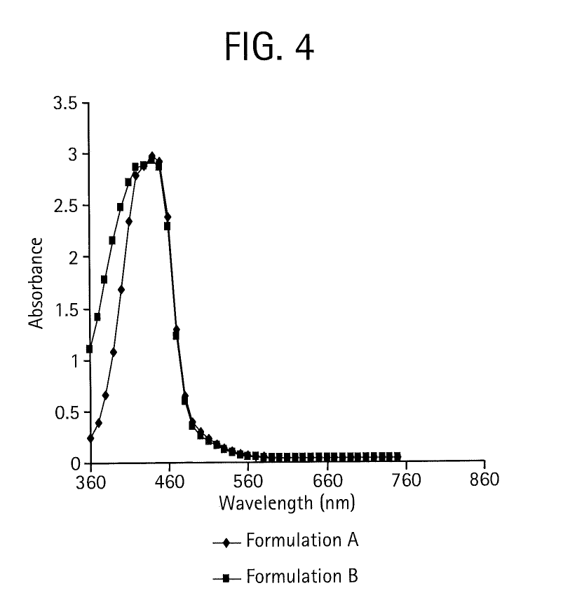

From Table 2, it can be seen that the two formulations are within 2.5 ΔE units of each other indicating that there is no significant visual difference under a D65 illuminant and a 10-degree observer. % Transmission values at 650 nm and 780 nm (primary laser wavelengths used in CD and DVD players) are also unaffected by the addition of a forensic authentication marker and a dynamic response authentication marker. In fact, addition of the fluorophore affects only the UV region of the absorption/transmission spectrum (up to 450 nm) as shown in FIGS. 4a and 4b.

### Example 4

A high performance liquid chromatography (HPLC) technique was used to quantify the level of a forensic authentication marker in a base polymer composition. Methanolysis HPLC, with an in-line UV detector (HPLC-Uv) was used to quantify a forensic authentication marker, dimethyl bisphenol cyclohexane (DMBPC) structural units, in a composition comprising a base polymer composition, a forensic polymer composition comprising a polymer and the forensic authentication marker, and a dynamic response authentication marker.

A blend of polycarbonate (i.e., the base polymer composition) was extruded with different levels of DMBPC copolymer (with 25 mole % DMBPC, the forensic authentication marker (FAM)) and a fluorophore additive. A UV-excitable long Stokes shift fluorophore emitting in the green region of the electromagnetic spectrum was obtained from Honeywell (Seelze, Germany) and used as the dynamic response authentication marker. The compositions of the samples are shown in Table 3, as measured in parts by weight of the tagged polymer composition.

TABLE 3
Composition of formulation used in multilevel tagging system

| Components | Sample C | Sample D | Sample E | Sample F | Sample G | Sample H | Sample I |
|---|---|---|---|---|---|---|---|
| Polycarbonate resin | 100 | 100 | 100 | 100 | 100 | 100 | 100 |
| (average molecular | | | | | | | |
| weight Mw of 17,700 | | | | | | | |
| determined by Gel | | | | | | | |
| Permeation | | | | | | | |
| Chromatography | | | | | | | |
| (GPC) against absolute | | | | | | | |
| PC standards) | | | | | | | |
| Forensic | 0.3 | 0.6 | 1.0 | 1.4 | 0.6 | 1.4 | 1.0 |
| Authentication Marker | (0.08 | (0.17 | (0.28 | (0.39 | (0.17 | (0.39 | (0.28 |
| DMBPC-BPA PC | FAM) | FAM) | FAM) | FAM) | FAM) | FAM) | FAM) |
| copolymer (25% | | | | | | | |
| DMBPC) Mw of | | | | | | | |
| 18,700 | | | | | | | |
| Glycerol monostearate | 0.03 | 0.03 | 0.03 | 0.03 | 0.03 | 0.03 | 0.03 |
| (Riken Vitamin Co.) | | | | | | | |
| Bis (2,4- | 0.02 | 0.02 | 0.02 | 0.02 | 0.02 | 0.02 | 0.02 |
| dicumylphenyl) | | | | | | | |
| pentaerythritol | | | | | | | |
| diphosphite (Dover | | | | | | | |
| Chemical Corporation) | | | | | | | |
| Dynamic Response | 0.05 | 0.04 | 0.04 | 0.06 | 0.04 | 0.05 | 0.06 |
| Authentication Marker | | | | | | | |
| Lumilux ® CD309OL | | | | | | | |
| from Honeywell | | | | | | | |
| Specialty Chemicals | | | | | | | |

The samples for the HPLC-UV analysis were prepared by weighing 0.3 gram of polycarbonate/DMBPC/fluorophore resin and recording the weight, pouring the sample into a French square bottle, adding 5 mL of an internal standard (i.e., 250 ppm 4-octylphenol in tetrahydrofuran) solution to the sample using a graduated pipette, putting a cap on the sample, and shaking for 30 minutes or until dissolved on a mechanical stirrer. Then, 2.7 mL of 10 wt % potassium hydroxide (KOH) in methanol was added and the combination was shaken on a mechanical stirrer for another 15-20 minutes. To this combination, 1.4 mL of acetic acid was added and the combination was shaken by hand and let rest for about one minute. Then, 750 μL of this solution was added to an HPLC sample vial and to that 750 μL of acetonitrile was added. A cap was placed onto the sample vial and the vial was shaken. The amount of DMBPC monomer in the solution was then measured by HPLC-UV.

To determine the concentration of DMBPC monomer in the preparation solution, the weight percent of DMBPC copolymer was converted. The DMBPC copolymer used for the resin analyzed contained a nominal 25 mole % of DMBPC. The molar percentage is determined solely on the molar ratio of DMBPC to DMBPC and bisphenol A. The amount of p-cumylphenol, the endcap for this resin, is assumed to be equal to the formulation amount, typically 5 mole %, which is based upon the quantity added prior to polymerization. DMBPC copolymer is added to BPA-polycarbonate (BPA-PC) resin through an extrusion process and is formulated based upon the total copolymer weight.

The conversion of weight percent of copolymer added to the amount of DMBPC monomer produced after methanolysis is calculated by measuring the amount of DMBPC copolymer, applying a correction factor, and then converting to monomer weight percent. The correction factor for loss of the carbonate linkages following sample methanolysis is determined based upon a nominal 25 mole % DMBPC copolymer with 5 mole % p-cumylphenol (PCP) endcap. The mole % is then converted to wt % by multiplying the mole % of DMBPC, BPA, and PCP by their respective molecular weights and dividing each by the total. The weight % of DMBPC monomer is determined by multiplying the weight % of DMBPC in the polymer by the correction factor. The wt % DMBPC monomer is then multiplied by the sample weight to obtain the amount of DMBPC monomer expected and divided by the final sample preparation volume to obtain the concentration of DMBPC expected.

The wt % of DMBPC copolymer added to the resin sample can also be back calculated. First, HPLC analysis is used to determine the concentration of DMBPC monomer in micrograms per milliliter (μg/mL) in the methanolysis solution and then the DMBPC monomer concentration is multiplied by the sample preparation volume to obtain the total amount of DMBPC monomer. This result is then divided by the total sample weight to obtain the wt % DMBPC monomer. Then, the weight % of DMBPC copolymer added is determined from the wt % DMBPC monomer using both the correction factor calculated above to adjust for the carbonate linkages and the nominal composition of the DMBPC copolymer (25 mol % DMBPC).

The HPLC instrument used was manufactured by Agilent Technologies, model 1100 HPLC and the column was Agilent Technologies Eclipse XDB-C8(2) 150 mm×4.6 mm, 5 u which was operated at a flow rate of 1.0 milliliter per minute (mL/minute) and a column temperature of 32° C.

The UV detector was a diode array. A diode array can measure multiple wavelengths at once. The diode array detector A wavelength was 380 nm and the diode array detector A bandwidth was 8 nm, while the diode array detector B wavelength was 280 nm and the diode array detector B bandwidth was 4 nm. Table 4 summarizes the samples analyzed and their corresponding forensic analytical marker formulations.

TABLE 4
DMBPC copolymer and fluorophore formulations

| | DMBPC | | |
|---|---|---|---|
| | copolymer | DMBPC | Fluorophore |
| Sample | (wt. %) | monomer (wt. %) | (wt. %) |
| C | 0.3 | 0.08 | 0.05 |
| D | 0.6 | 0.17 | 0.04 |
| E | 1.0 | 0.28 | 0.04 |
| F | 1.4 | 0.39 | 0.06 |
| G | 0.6 | 0.17 | 0.04 |
| H | 1.4 | 0.39 | 0.05 |
| I | 1.0 | 0.28 | 0.06 |

A polycarbonate resin was formulated at four different levels, 0.3, 0.6, 1.0, and 1.4 wt %, of DMBPC-BPA copolymer with 25% DMBPC. The DMBPC monomer was present at 0.08, 0.17, 0.28, and 0.39 wt % respectively corresponding to the wt % of DMBPC copolymer. Samples from each of the four different levels were analyzed by methanolysis HPLC in triplicate. A one way analysis of variance (ANOVA) was performed to determine if the results obtained from HPLC were able to distinguish between the various levels with 95% confidence. The 95% confidence levels did not overlap and therefore the levels can be differentiated from each other. Table 5 shows the results from the HPLC measurements for DMBPC copolymer content, monomer content, and the standard deviation for each.

TABLE 5
Formulation vs. HPLC results for DMBPC copolymer and monomer

| | | Mean | | | Mean | |
|---|---|---|---|---|---|---|
| | | Measured | Std | Formulated | Measured | Std Dev |
| | Formulated | Dev HPLC | HPLC | DMBPC | HPLC | HPLC |
| | DMBPC | copolymer | copolymer | monomer | monomer | monomer |
| Sample | (wt %) | (wt %) | (%) | (wt %) | (wt %) | (%) |
| C | 0.3 | 0.29 | 0.01 | 0.08 | 0.082 | 0.002 |
| D | 0.6 | 0.75 | 0.03 | 0.17 | 0.210 | 0.009 |
| E | 1.0 | 0.95 | 0.03 | 0.28 | 0.265 | 0.010 |
| F | 1.4 | 1.38 | 0.01 | 0.39 | 0.385 | 0.002 |

As can be seen from Table 5, the standard deviation for measuring the amount of DMBPC monomer in each sample was at least within 0.01%, and for the monomer content of 0.08 wt % and 0.39 wt %, the standard deviation was within 0.002%. Since it was determined that the HPLC method is acceptable to differentiate between formulations with 95% confidence, the ability to consistently manufacture polycarbonate with low amounts of DMBPC copolymer was also studied. A bias or high level of variation in the level of DMBPC in the finished product could cause a loss in resolution between different formulation levels, e.g. Sample D was formulated at 0.6 wt % DMBPC, but measured at 0.75 wt % DMBPC by HPLC. To determine whether there is a consistent bias throughout a run causing the deviation or whether the difference is a result of variability within a manufacturing run, a series of samples formulated at 1.0 wt % DMBPC copolymer (i.e., 0.28 wt % DMBPC monomer) were analyzed at different times within a single extrusion run. Table 6 gives the HPLC results from pellets sampled each hour during the extrusion run.

TABLE 6
DMBPC content for pellet samples in a single extrusion run

| | | DMBPC copolymer | DMBPC monomer |
|---|---|---|---|
| Sample | Time Sampled | (wt %) | (wt %) |
| J | 1:00 PM | 1.00 | 0.28 |
| K | 2:00 PM | 1.37 | 0.38 |
| L | 3:00 PM | 1.02 | 0.29 |
| M | 4:00 PM | 0.93 | 0.26 |
| N | 5:00 PM | 1.07 | 0.30 |
| O | 6:00 PM | 1.06 | 0.30 |

The average for DMBPC copolymer was 1.07 wt % with a standard deviation of 0.15 wt %, while the average for DMBPC monomer was 0.30 wt % with a standard deviation of 0.04 wt %. The standard deviation for the manufacturing run was greater than for the HPLC measurement itself. The major source of variation was in the pellets sampled at 2:00 PM. The 2:00 PM pellets would have been classified at the higher 1.4 wt % formulation level. Excluding the 2:00 PM pellet sample, the average was 1.02 wt % DMBPC copolymer with a standard deviation of 0.05 wt %, an acceptable number for correct classification of the resin.

As can be seen from the data in Table 5, HPLC-UV detection of DMBPC copolymer is able to distinguish between different loading formulations. The results from the HPLC-UV tests show that different formulation levels of the use of DMBPC copolymer as the forensic authentication polymer composition using DMBPC structural units as forensic authentication markers can be measured accurately and reproducibly. The method was able to differentiate between four different levels of forensic authentication markers with greater than 95% confidence.

In an embodiment, the forensic analytical marker is present in an amount less than or equal to about 0.08 wt % based upon the total weight of the tagged polymer composition, specifically less than or equal to about 0.17 wt % based upon the total weight of the tagged polymer composition, more specifically less than or equal to about 0.28 wt % based upon the total weight of the tagged polymer composition, and even more specifically less than or equal to about 0.39 wt % based upon the total weight of the tagged polymer composition. In an embodiment, the dynamic response analytical marker is present in an amount of less than or equal to about 0.04 wt % based upon the total weight of the tagged polymer composition, specifically less than or equal to about 0.05 wt % based upon the total weight of the tagged polymer composition, and more specifically less than or equal to about 0.06 wt % based upon the total weight of the tagged polymer composition.

The methods and articles disclosed herein provide a multi-level tagging method useful in the authentication and confirmation of the source and identity of polymer-based articles, especially polycarbonate based materials and of articles made from such base polymer compositions.

The presence of forensic authentication markers and dynamic response authentication markers provide a taggant (i.e., a base polymer composition) that can generally be available only to legitimate producers of articles made from such base polymer compositions. In addition, the nature of the forensic authentication markers ensures that they are detectable only with the use of relatively sophisticated forensic analytical techniques. Thus, the forensic authentication markers function as ‘hidden’ taggants that are generally invisible to counterfeiters and illegitimate producers and sellers.

The presence of both forensic authentication and dynamic response authentication markers in a particular article or data storage media provides for a multi-level determination that results in the optimal use of resources. By using both a ‘hidden’ forensic authentication marker and a dynamic response authentication marker, counterfeiters and illegitimate producers and sellers may be more readily identified and apprehended.

HPLC-UV can be used to measure low levels of DMBPC monomer (e.g., less than or equal to 1 ppm which is equivalent to 0.02 wt % of forensic authentication marker), which is added during pellet extrusion in the form of a small quantity of 25 mole % DMBPC copolymer. HPLC utilizing fluorescence detection can be used to quantify the amount of DMBPC monomer to 0.1 ppm which is equivalent to a 0.002 wt % at a loading of 25 mole % DMBPC copolymer in the resin sample. Either method can be applied to various forms of samples, including, for example, pellets or molded parts (e.g., optical discs, containers, or bottles).

Other embodiments include packaging material (and especially drug packaging), automotive parts like lenses, telecom accessories (like cell phone covers), computers and consumer electronics, construction materials, medical devices, eyewear products, films, and sheets (including those used in display applications), and the like.

While the invention has been described with reference to an exemplary embodiment, it can be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention can include all embodiments falling within the scope of the appended claims.

The terms “first,” “second,” and the like, “primary,” “secondary,” and the like, as used herein do not denote any order, quantity, or importance, but rather are used to distinguish one element from another. The terms “a” and “an” do not denote a limitation of quantity, but rather denote the presence of at least one of the referenced item. “Optional” or “optionally” means that the subsequently described event or circumstance may or may not occur, and that the description includes instances where the event occurs and instances where it does not. Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

The modifier “about” used in connection with a quantity is inclusive of the stated value and has the meaning dictated by the context (e.g., includes the degree of error associated with measurement of the particular quantity). The endpoints of all ranges directed to the same component or property are inclusive of the endpoint and independently combinable The suffix “(s)” as used herein is intended to include both the singular and the plural of the term that it modifies, thereby including one or more of that term (e.g., the colorant(s) includes one or more colorants). As used herein, “combination” is inclusive of blends, mixtures, alloys, reaction products, and the like. The notation “±10%” means that the indicated measurement may be from an amount that is minus 10% to an amount that is plus 10% of the stated value.

Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments. All cited patents, patent applications, and other references are incorporated herein by reference in their entirety. However, if a term in the present application contradicts or conflicts with a term in the incorporated reference, the term from the present application takes precedence over the conflicting term from the incorporated reference.

1. A tagged polymer composition, comprising:
a base polymer composition comprising a forensic polymer composition and a dynamic response authentication marker, wherein the forensic polymer composition comprises a marked polymer having a forensic authentication marker;
wherein the forensic authentication marker is present in an amount sufficient to be detected by a forensic analytical technique;
wherein the dynamic response authentication marker is present in an amount sufficient to be detected by a dynamic response analytical technique; and
wherein, when tested, the dynamic response authentication marker has a change in mode.

2. The tagged polymer composition of claim 1, wherein the forensic authentication marker and the dynamic response authentication marker are present in an amount such that properties of the tagged polymer composition including optical, physical, rheological, thermal, and processing properties vary from the base polymer composition less than or equal to 20%.

3. The tagged polymer composition of claim 1, wherein the forensic authentication marker is present in the tagged polymer in an amount of less than or equal to about 10 wt %, based on the total weight of the tagged polymer composition.

4. The tagged polymer composition of claim 3, wherein the forensic authentication marker is present in the tagged polymer in an amount of less than or equal to about 0.5% weight, based on the total weight of the tagged polymer composition.

5. The tagged polymer composition of claim 1, wherein the forensic authentication marker is a member selected from the group consisting of alkyl groups of 2 or more carbon atoms, cycloaliphatic groups of 3 or more carbon atoms, —OCH₃ groups, —CH₃Si groups, methyl groups attached to an aryl moiety, divalent substituted phenol groups, terminal substituted phenol groups, DMBPC structural units, and (—CH₂—)ₙ groups where n is a number of from 4 to 14.

6. The tagged polymer composition of claim 1, wherein the base polymer composition comprises polycarbonate.

7. The tagged polymer composition of claim 6, wherein the forensic authentication marker is a monomer of a copolymer miscible with the base polymer composition.

8. The tagged polymer composition of claim 7, wherein the forensic authentication marker comprises structural units of DMBPC monomer.

9. The tagged polymer composition of claim 1, wherein the dynamic response authentication marker comprises a member selected from the group consisting of a fluorophore, a semi-conducting luminescent nanoparticle, and mixtures comprising at least one of the foregoing.

10. The tagged polymer composition of claim 1, wherein the dynamic response authentication marker is present in the tagged polymer in an amount of about 10⁻⁵ wt % to about 0.1 wt %, based on the total weight of the tagged polymer composition.

11. A molded article comprising the tagged polymer composition of claim 1.

12. The molded article of claim 11, wherein the molded article is a data storage media.

13. A method of authenticating that a test polymer is a tagged polymer composition, wherein the tagged polymer composition comprises a base polymer composition comprising a forensic polymer composition and a dynamic response authentication marker, wherein the forensic polymer composition comprises a marked polymer having a forensic authentication marker; wherein the forensic authentication marker is present in an amount sufficient to be detected by a forensic analytical technique; wherein the dynamic response authentication marker is present in an amount sufficient to be detected by a dynamic response analytical technique; and wherein, when tested, the dynamic response authentication marker has a change in mode, the method comprising:
testing the test polymer for the forensic authentication marker using a forensic analytical technique;
testing the test polymer for the dynamic response authentication marker using a dynamic response analytical technique; and
authenticating that a test polymer is a tagged polymer composition if the forensic authentication marker and dynamic response authentication marker are detected.

14. The method of claim 13, wherein the forensic authentication marker is a member selected from the group consisting of alkyl groups of 2 or more carbon atoms, cycloaliphatic groups of 3 or more carbon atoms, —OCH₃ groups, —CH₃Si groups, methyl groups attached to an aryl moiety, divalent substituted phenol groups, and terminal substituted phenol groups, (—CH₂—)ₙ groups where n is a number of from 4 to 14, and DMBPC structural units; and
wherein the dynamic response authentication marker is a member selected from the group consisting of a fluorophore, a semi-conducting luminescent nanoparticle, and combinations comprising at least one of the foregoing.

15. The method of claim 13, wherein the forensic analytical technique is selected from the group consisting of resonance spectroscopy methods, SEM-EDX, XPS-ESCA, gas or liquid chromatography, and combinations comprising at least one of the foregoing forensic analytical techniques.

16. The method of claim 13, wherein the dynamic response analytical technique is selected from the group consisting of luminescence spectroscopy, fluorescence spectroscopy, vibrational spectroscopy, electronic spectroscopy, visual observation under specific lighting conditions, color spectrophotometry, and combinations comprising at least one of the foregoing dynamic response analytical techniques.

17. The method of claim 15, wherein the forensic analytical technique is selected from the group consisting of NMR and HPLC and the dynamic response analytical technique is selected from the group consisting of visual observation, luminescence spectroscopy, and fluorescence spectroscopy.

18. The method of claim 17, wherein the forensic analytical technique is NMR and the dynamic response analytical technique is fluorescence spectroscopy.

19. The method of claim 17, wherein the forensic analytical technique is HPLC and the dynamic response analytical technique is fluorescence spectroscopy.

20. The method of claim 17, wherein the forensic authentication marker is a DMBPC structural unit and the dynamic response analytical marker is a fluorophore.
